(19) United States
(12) Patent Application Publication
(10) Pub. No.: US 2005/0285818 A1
(43) Pub. Date: Dec. 29, 2005

(54) Method of driving plasma display panel

(75) Inventor: Hirokazu Hashikawa, Nakakoma-gun (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/167,822

(22) Filed: Jun. 28, 2005

(30) Foreign Application Priority Data
Jun. 29, 2004 (JP) 2004-191115

(51) Int. Cl. G09G 3/28

(52) U.S. Cl. 345/63

(57) ABSTRACT

A method of driving a plasma display panel which is capable of increasing the number of intermediate luminance levels which can be represented in units of pixel cells while suppressing spurious borders. Each frame display period includes a first sub-field group which has a plurality of sub-fields arranged in succession such that the values of luminance weighting coefficients assigned thereto advance in a form of geometric series with a common ratio being set to two, and a second sub-field group which includes a sub-field assigned the largest luminance weighting coefficient and has a plurality of sub-fields arranged in succession such that the value of luminance weighting coefficients assigned thereto advance in a form of arithmetic series. A sub-field assigned the largest luminance weighting coefficient is placed at a position other than the head and tail of the frame display period.

### BACKGROUND OF THE INVENTION

1. Field of the Invention

The present invention relates to a method of driving a plasma display panel.

2. Description of the Related Art

As a thin display device, AC discharge type plasma display panel (hereinafter called the “PDP”) is known, which utilizes a light emitting phenomenon associated with a discharge to display images. The PDP has a plurality of discharge cells, corresponding to pixels, arranged in a matrix shape. In this structure, each discharge cell has only two states, i.e., a light emitting state (highest luminance level) during a discharge, and a non-light emitting state (lowest luminance level) during a non-discharge. Therefore, a gradation driving process based on a sub-field method is implemented for permitting the PDP, which has such discharge cells, to carry out image displays at intermediate luminance levels represented by input video signals. In the gradation driving technique based on the sub-field method, a display period for one field (or frame) of an input video signal is divided into N sub-fields, and discharge cells are driven to emit light for each of the sub-fields. Each of the sub-fields is allocated a light emitting period corresponding to a weighting coefficient applied to the sub-field.

For example, when a display period for one period is divided into six sub-fields SF1-SF6, as shown in FIG. 1, for driving a plasma display panel, each of the sub-fields SF1-SF6 is allocated a light emitting period as follows, such that each of discharge cells is driven to emit light for the allocated period:

SF1:1

SF2:2

SF3:4

SF4:8

SF5:16

SF6:32

In this driving method, for displaying a luminance level “32,” for example, the discharge cells are driven to emit light only for SF6 of the sub-fields SF1-SF6. In this way, light is emitted for a period “32” in a display period of one field, so that a corresponding luminance level “32” is viewed for the light emitting period. On the other hand, for displaying a luminance level “31,” the discharge cells are driven to emit light for the remaining sub-fields SF1-SF5 except for the sub-field SF6. In this way, since light is emitted for a period “31” (=1+2+4+8+16) in the display period of one field, so that a corresponding luminance level “31” is viewed for the light emitting period.

However, since the display at luminance level “32” and the display at luminance level “31,” as described above, are reverse to each other in the period in which the discharge cells are emitting light and in the period in which the discharge cells are extinguished, spurious borders can be viewed. Specifically, a discharge cell which should be driven to emit light at luminance “31” is in a non-light emitting state in a period in which a discharge cell which should be driven to emit light at luminance “32” is emitting light. On the other hand, the discharge cell which should be driven to emit light at luminance “32” is in a non-light emitting state in a period in which a discharge cell which should be driven to emit light at luminance “31” is emitting light. Therefore, if a region in which a discharge cell which should be driven to emit light at luminance “32” is adjacent to a discharge cell which should be driven to emit light at luminance “31,” the non-light emitting state (or light emitting state) will be viewed in succession if a line of sight is moved between both the regions at a timing at which SF6 is switched to SF5 as shown in FIG. 1. In this event, a dark (or bright) line is viewed as a spurious border on the boundary between the region in which the luminance level “32” is displayed and the region in which the luminance level “31” is displayed.

Thus, a gradation driving method has been proposed for preventing such spurious borders. See, for example, FIG. 3 of Japanese Patent Kokai No. 2000-231362 (Patent Document 1).

This gradation driving method divides a display period of one field into 14 sub-fields SF1-SF14, and executes one of a first gradation driving pattern to a fifteenth gradation driving pattern as shown in FIG. 2 in accordance with an input video signal. In FIG. 2, discharge cells are driven to emit light in sub-fields marked with a white circle, while discharge cells are kept extinguished in sub-fields subsequent to a sub-field marked with a black circle. Specifically, except for the first gradation driving pattern for displaying black, the discharge cells are driven to emit light without fail in the first sub-field SF1, and subsequently, the discharge cells are driven to emit light in succession in each of a number of sub-fields in accordance with a luminance level to be displayed. According to this gradation driving method, a display cell which is once brought into the non-light emitting state within one field period will not return to the light emitting state again. Consequently, the spurious borders are suppressed because there is no combination of light emission pattern including alternations of a light emitting period and a non-light emitting period of the discharge cells within one field display period, as shown in FIG. 1.

However, this gradation driving method cannot represent all intermediate luminance levels represented by input video signals because the number of gradation levels which can be represented for each discharge cell is merely the sum of the number of sub-fields into which each field is divided and one.

### OBJECT AND SUMMARY OF THE INVENTION

The present invention has been made in view of the foregoing problem, and it is an object of the invention to provide a method of driving a plasma display panel which is capable of increasing the number of intermediate luminance levels which can be represented in units of pixel cells while suppressing the spurious borders.

A method of driving a plasma display panel according to a first aspect of the present invention is adapted to drive a plasma display panel having a plurality of discharge cells corresponding to pixels every N sub-fields (N is an integer equal to or larger than two) defining each frame display period, wherein each of the sub-fields comprises an addressing step for setting each of the discharge cells to one of a light emitting mode or a non-light emitting mode in accordance with pixel data corresponding to an input video signal, and a sustaining step for forcing only the discharge cells set in the light emitting mode to repeatedly produce sustain discharges a number of times corresponding to a luminance weighting coefficient assigned to each of the sub-fields to sustain a light emitting state, each frame display period includes a first sub-field group which has a plurality of the sub-fields arranged in succession such that the values of the luminance weighting coefficients assigned to the respective sub-fields advance in a form expressed by:
G(n)=2⁽ⁿ⁻¹⁾
where G represents Value of Luminance Weighting Coefficient, and

n represents Position of Sub-field in Group, and

a second sub-field group including a sub-field having the largest luminance weighting coefficient of the N sub-fields and having a plurality of sub-fields arranged in succession such that the values of the luminance weighting coefficients assigned to the respective sub-fields advance in a form expressed by:
G(n)=a+(n-1)·d
where G represents Value of Luminance Weighting Coefficient,

n represents Position of Sub-field in Group,

a represents Initial Value of Luminance Weighting Coefficient, and

d represents Predetermined Value, and

the sub-field having the largest luminance weighting coefficient is placed at a position other than the head and the tail of the frame display period.

A method of driving a plasma display panel according to a second aspect of the present invention is adapted to drive a plasma display panel having a plurality of discharge cells corresponding to pixels every N sub-fields (N is an integer equal to or larger than two) defining each frame display period, wherein each of the sub-fields comprises an addressing step for setting each of the discharge cells to one of a light emitting mode or a non-light emitting mode in accordance with pixel data corresponding to an input video signal, and a sustaining step for forcing only the discharge cells set in the light emitting mode to repeatedly produce sustain discharges a number of times corresponding to a luminance weighting coefficient assigned to each of the sub-fields to sustain a light emitting state, each frame display period includes a first sub-field group having a plurality of the sub-fields arranged in succession such that the values of the luminance weighting coefficients assigned to the respective sub-fields advance in a form of geometric series with a common ratio set to two, a second sub-field group including a plurality of the sub-field group arranged such that the values of the luminance weighting coefficients increase from the head to the tail, and a third sub-field group having a plurality of the sub-fields arranged such that the values of the luminance weighting coefficients decrease from the head to the tail, and a sub-field assigned the largest luminance weighting coefficient in the N sub-fields is placed at a position other than the head and the tail of the frame display period.

Each frame display period includes a first sub-field group which has a plurality of sub-fields arranged in succession such that the values of luminance weighting coefficients assigned thereto advance in a form of geometric series with a common ratio set to two, and a second sub-field group which includes a sub-field assigned the largest luminance weighting coefficient and has a plurality of sub-fields arranged in succession such that the value of luminance weighting coefficients assigned thereto advance in a form of arithmetic series. A sub-field assigned the largest luminance weighting coefficient is placed at a position other than the head and tail of the frame display period.

### BRIEF DESCRIPTION OF THE DRAWINGS

FIG. 1 is a diagram showing a light emission driving sequence based on a sub-field method, and an example of a light emission pattern which causes a spurious border;

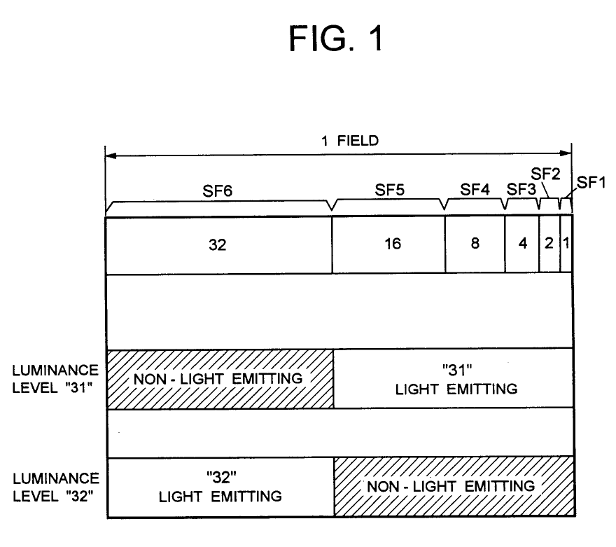

FIG. 2 is a diagram showing light emission patterns which suppress the occurrence of spurious borders;

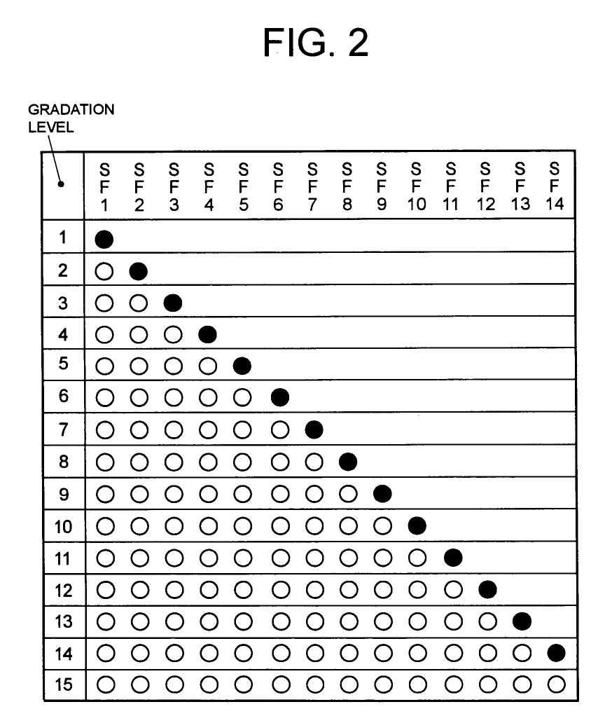

FIG. 3 is a diagram showing the configuration of a plasma display device which comprises a panel driver for driving a plasma display panel to display halftone images in accordance with a driving method of the present invention;

FIG. 4 is a diagram showing an example of a light emission driving sequence when a plasma display panel is driven to display halftone images using a selective write addressing method;

FIG. 5 is a diagram showing a variety of light emission patterns (first to 32nd gradation levels) within one frame display period when the plasma display panel is driven to display halftone images based on the light emission driving sequence shown in FIG. 4;

FIG. 6 is a diagram showing a variety of light emission patterns (33rd to 64th gradation levels) within one frame display period when the plasma display panel is driven to display halftone images based on the light emission driving sequence shown in FIG. 4;

FIG. 7 is a diagram showing a variety of light emission patterns (65th to 96th gradation levels) within one frame display period when the plasma display panel is driven to display halftone images based on the light emission driving sequence shown in FIG. 4;

FIG. 8 is a diagram showing a variety of light emission patterns (97th to 128th gradation levels) within one frame display period when the plasma display panel is driven to display halftone images based on the light emission driving sequence shown in FIG. 4;

FIG. 9 is a diagram showing a variety of light emission patterns (129th to 160th gradation levels) within one frame display period when the plasma display panel is driven to display halftone images based on the light emission driving sequence shown in FIG. 4;

FIG. 10 is a diagram showing a variety of light emission patterns (161st to 192nd gradation levels) within one frame display period when the plasma display panel is driven to display halftone images based on the light emission driving sequence shown in FIG. 4;

FIG. 11 is a diagram showing a variety of light emission patterns (193rd to 224th gradation levels) within one frame display period when the plasma display panel is driven to display halftone images based on the light emission driving sequence shown in FIG. 4;

FIG. 12 is a diagram showing a variety of light emission patterns (225th to 256th gradation levels) within one frame display period when the plasma display panel is driven to display halftone images based on the light emission driving sequence shown in FIG. 4;

FIG. 13 is a diagram showing an example of a light emission driving sequence when a plasma display panel is driven to display halftone images using a selective erasure addressing method;

FIG. 14 is a diagram showing a variety of light emission patterns (first to 256th gradation levels) within one frame display period when a plasma display panel is driven to display halftone images based on the light emission driving sequence shown in FIG. 13;

FIG. 15 is a diagram showing an example of a light emission driving sequence based on the selective write addressing method in consideration of an inverse γ correction;

FIG. 16 is a diagram showing a variety of light emission patterns (first to 32nd gradation levels) within one frame display period when a plasma display panel is driven to display halftone images based on the light emission driving sequence shown in FIG. 15;

FIG. 17 is a diagram showing a variety of light emission patterns (33rd to 64th gradation levels) within one frame display period when the plasma display panel is driven to display halftone images based on the light emission driving sequence shown in FIG. 15;

FIG. 18 is a diagram showing a variety of light emission patterns (65th to 96th gradation levels) within one frame display period when a plasma display panel is driven to display halftone images based on the light emission driving sequence shown in FIG. 15;

FIG. 19 is a diagram showing a variety of light emission patterns (97th to 128th gradation levels) within one frame display period when the plasma display panel is driven to display halftone images based on the light emission driving sequence shown in FIG. 15;

FIG. 20 is a diagram showing a variety of light emission patterns (129th to 158th gradation levels) within one frame display period when the plasma display panel is driven to display halftone images based on the light emission driving sequence shown in FIG. 15;

FIG. 21 is a diagram showing an example of a light emission driving sequence based on the selective erasure addressing method in consideration of an inverse γ correction;

FIG. 22 is a diagram showing a variety of light emission patterns (first to 32nd gradation levels) within one frame display period when a plasma display panel is driven to display halftone images based on the light emission driving sequence shown in FIG. 21;

FIG. 23 is a diagram showing a variety of light emission patterns (33rd to 64th gradation levels) within one frame display period when the plasma display panel is driven to display halftone images based on the light emission driving sequence shown in FIG. 21;

FIG. 24 is a diagram showing a variety of light emission patterns (65th to 96th gradation levels) within one frame display period when the plasma display panel is driven to display halftone images based on the light emission driving sequence shown in FIG. 21;

FIG. 25 is a diagram showing a variety of light emission patterns (97th to 128th gradation levels) within one frame display period when the plasma display panel is driven to display halftone images based on the light emission driving sequence shown in FIG. 21;

FIG. 26 is a diagram showing a variety of light emission patterns (129th to 158th gradation levels) within one frame display period when the plasma display panel is driven to display halftone images based on the light emission driving sequence shown in FIG. 21;

FIG. 27 is a diagram showing an example of a light emission driving sequence based on the selective write addressing method in consideration of an inverse γ correction;

FIG. 28 is a diagram showing a variety of light emission patterns (first to 32nd gradation levels) within one frame display period when a plasma display panel is driven to display halftone images based on the light emission driving sequence shown in FIG. 27;

FIG. 29 is a diagram showing a variety of light emission patterns (33rd to 64th gradation levels) within one frame display period when the plasma display panel is driven to display halftone images based on the light emission driving sequence shown in FIG. 27;

FIG. 30 is a diagram showing a variety of light emission patterns (65th to 96th gradation levels) within one frame display period when the plasma display panel is driven to display halftone images based on the light emission driving sequence shown in FIG. 27;

FIG. 31 is a diagram showing a variety of light emission patterns (97th to 136th gradation levels) within one frame display period when the plasma display panel is driven to display halftone images based on the light emission driving sequence shown in FIG. 27;

FIG. 32 is a diagram showing an example of a light emission driving sequence based on the selective erasure addressing method in consideration of an inverse γ correction;

FIG. 33 is a diagram showing a variety of light emission patterns (first to 32nd gradation levels) within one frame display period when a plasma display panel is driven to display halftone images based on the light emission driving sequence shown in FIG. 32;

FIG. 34 is a diagram showing a variety of light emission patterns (33rd to 64th gradation levels) within one frame display period when the plasma display panel is driven to display halftone images based on the light emission driving sequence shown in FIG. 32;

FIG. 35 is a diagram showing a variety of light emission patterns (65th to 96th gradation levels) within one frame display period when the plasma display panel is driven to display halftone images based on the light emission driving sequence shown in FIG. 32; and

FIG. 36 is a diagram showing a variety of light emission patterns (97 to 136th gradation levels) within one frame display period when the plasma display panel is driven to display halftone images based on the light emission driving sequence shown in FIG. 32.

### DETAILED DESCRIPTION OF THE EMBODIMENTS

### First Embodiment

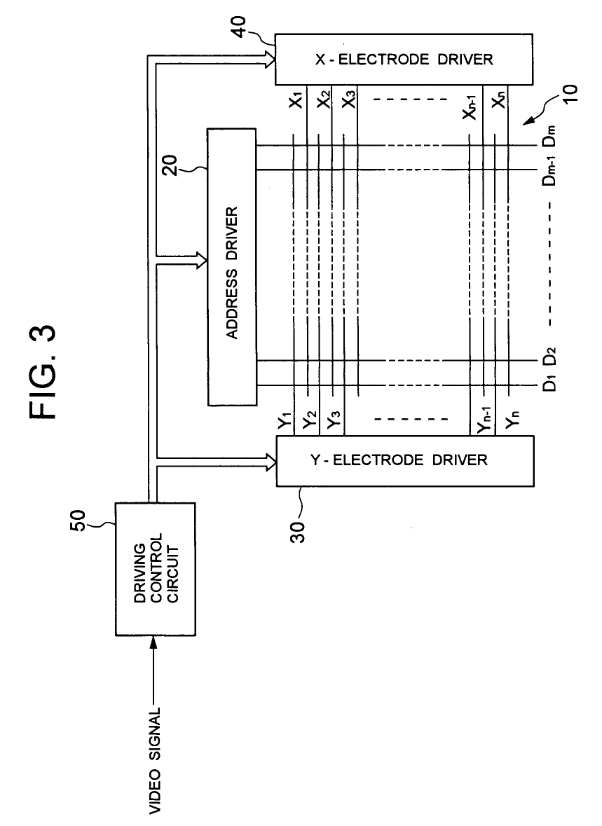

FIG. 3 is a diagram generally showing the configuration of a plasma display device for driving a plasma display panel as a display panel to emit light based on a driving method according to the present invention.

The plasma display device comprises a panel driver section including an address driver 20, a Y-electrode driver 30, an X-electrode driver 40, and a driving control circuit 50, and a PDP 10 as a plasma display panel.

A front transparent substrate (not shown), which serves as a display plane of the PDP 10, is formed with row electrodes X₁-Xₙ and row electrodes Y₁-Yₙ, each of which extends in the horizontal direction of the screen, respectively. A back substrate (not shown) of the PDP 10 in turn is formed with column electrodes D₁-Dₘ, each of which extends in the vertical direction of the screen. These row electrodes X₁-Xₙ and Y₁-Yₙ are alternately arranged as X, Y, X, Y, . . . , on the front transparent substrate, and a pair of row electrodes (X, Y) adjacent to each other make up each display line on the PDP 10. A discharge space is defined between the front transparent substrate and the back substrate, and is filled with a discharge gas, and discharge cells (pixel cells) are formed at intersections of the row electrode pairs with the column electrodes including the discharge space.

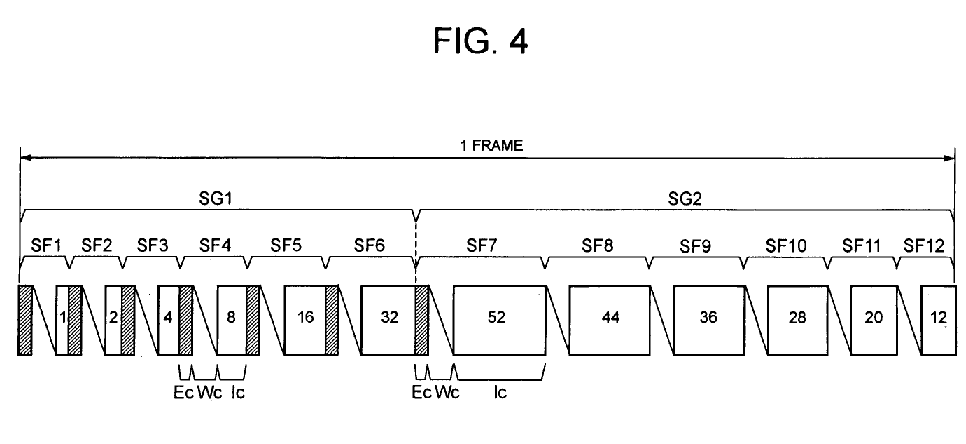

The driving control circuit 50 converts an input video signal to pixel data for each pixel to generate pixel driving data for specifying, based on the pixel data, whether each discharge cell is set to a light emitting mode or a non-light emitting mode in an addressing stage (later described) in each of sub-fields. The pixel driving data is supplied to the address driver 20. The driving control circuit 50 further generates a variety of timing signals in accordance with a light emission driving sequence as shown in FIG. 4, and supplies the timing signals to each of the Y-electrode driver 30 and X-electrode driver 40. Each of the address driver 20, Y-electrode driver 30, and X-electrode driver 40 applies a variety of driving pulses to the column electrodes D, or row electrodes X, Y in response to the timing signals supplied thereto from the driving control circuit 50.

Specifically, the panel driving section comprising the address driver 20, Y-electrode driver 30, X-electrode driver 40, and driving control circuit 50 divides a display period of one frame into sub-fields SF1-SF12 and drives the PDP 10 to display a halftone image based on the light emission driving sequence shown in FIG. 4. Luminance weighting coefficients are applied to the sub-fields SF1-SF12, respectively, as follows:

SF1: 1

SF2: 2

SF3: 4

SF4: 8

SF5: 16

SF6: 32

SF7: 52

SF8: 44

SF9: 36

SF10: 28

SF11: 20

SF12: 12

In this event, in the former half of one frame display period, the sub-fields SF1, SF2, SF3, SF4, SF5, SF6 belonging to a first sub-field group SG1 are arranged for emitting light of low luminance components, as shown in FIG. 4.

Specifically, in the first sub-field group SG1, the respective sub-fields are arranged such that the values of the luminance weighting coefficients assigned to the respective sub-field increase in a form of geometric series with a common ratio set to two. On the other hand, in the latter half of one frame display period, sub-fields SF7-SF12 belonging to a second sub-field group SG2 are arranged for emitting light of high luminance components, as shown in FIG. 4.

Specifically, in the second sub-field group SG2, the respective sub-fields are arranged from the one assigned the largest luminance weighting coefficient in the order of SF7, SF8, SF9, SF10, SF11, SF12 such that the values of the luminance weighting coefficients assigned to the respective sub-fields decreases “eight” by “eight.”

In each of the sub-fields SF1-SF6 belonging to the first sub-field group SG1, the panel driving section executes a full erasure stage Ec, a selective write addressing stage Wc, and a sustain stage Ic, respectively. On the other hand, in each of the sub-fields SF7-SF12 belonging to the second sub-field group SG2, the panel driving section executes the selective write stage Wc and sustain stage Ic, respectively. The panel driving section executes the full erasure stage Ec only for the first sub-field SF7 in the second sub-field group SG2 prior to the selective write addressing stage Wc.

In the full erasure stage Ec, the panel driving section forces all the discharge cells of the PDP 10 to simultaneously produce an erasure discharge to leave the amount of wall charges in all the discharge cells equal to or less than a predetermined amount. With the erasure discharge, all the discharge cells are forcedly set to a non-light emitting mode.

In the selective write addressing stage Wc, the panel driving section selectively forces only those discharge cells which are specified in a light emitting mode to produce a write address discharge based on the pixel driving data. In this event, a predetermined amount of wall charge is formed within each of discharge cells which are forced to produce the write address discharge, and these discharge cells are set to the light emitting mode. Discharge cells which are not forced to produce the write address discharge are maintained in a current mode (light emitting mode or non-light emitting mode).

In the sustain stage Ic, the panel driving section forces only the discharge cells set in the light emitting mode to repeatedly produce sustain discharges over a period (or a number of times) corresponding to the luminance weighting coefficient of the sub-field to maintain the light emitting state associated with the discharge.

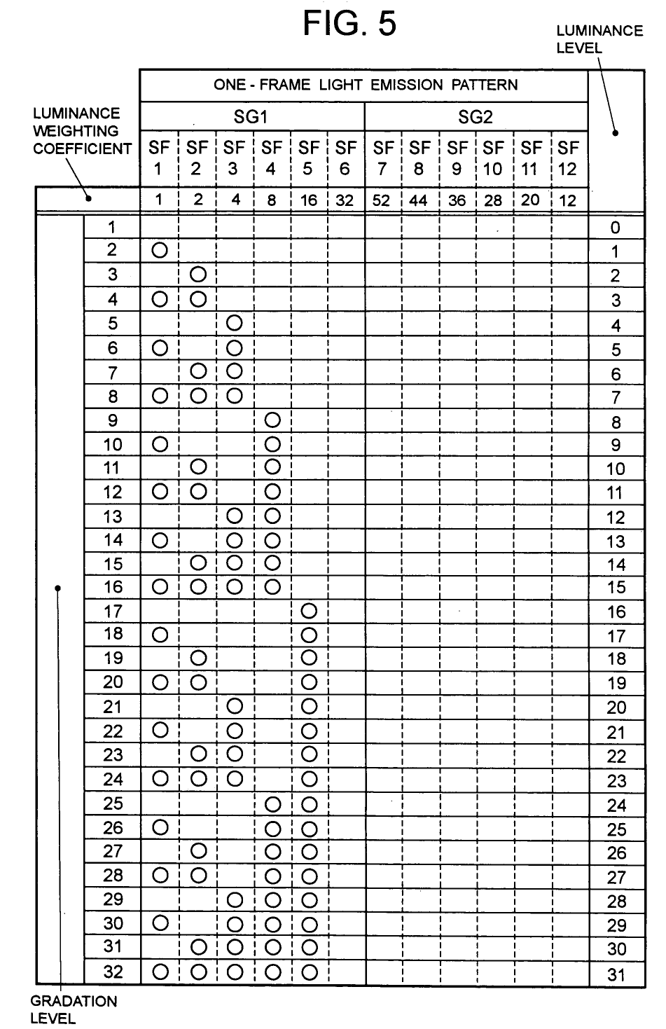

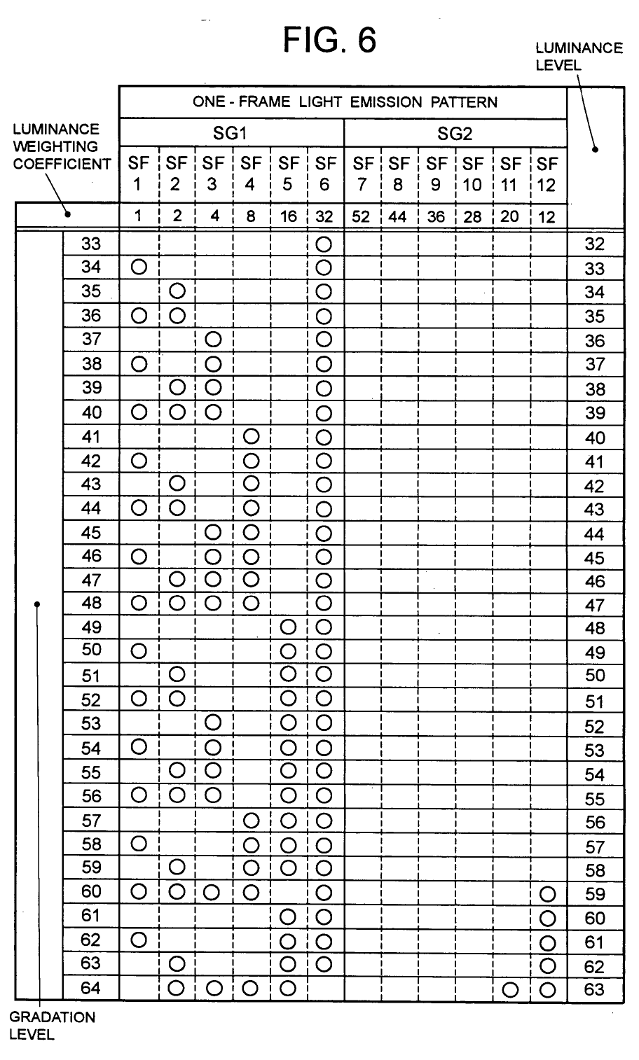

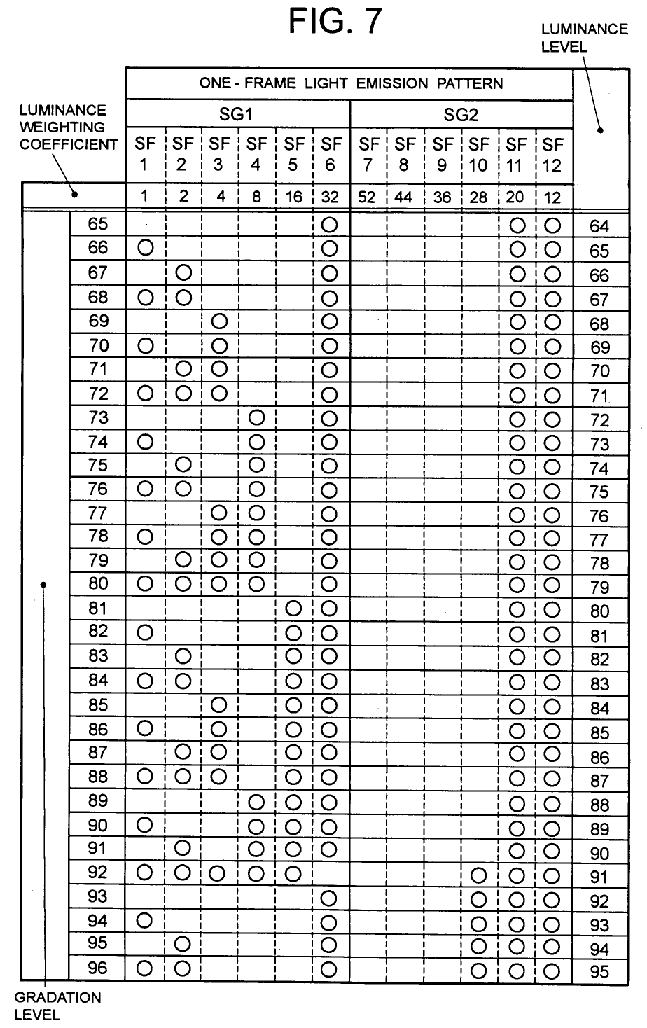

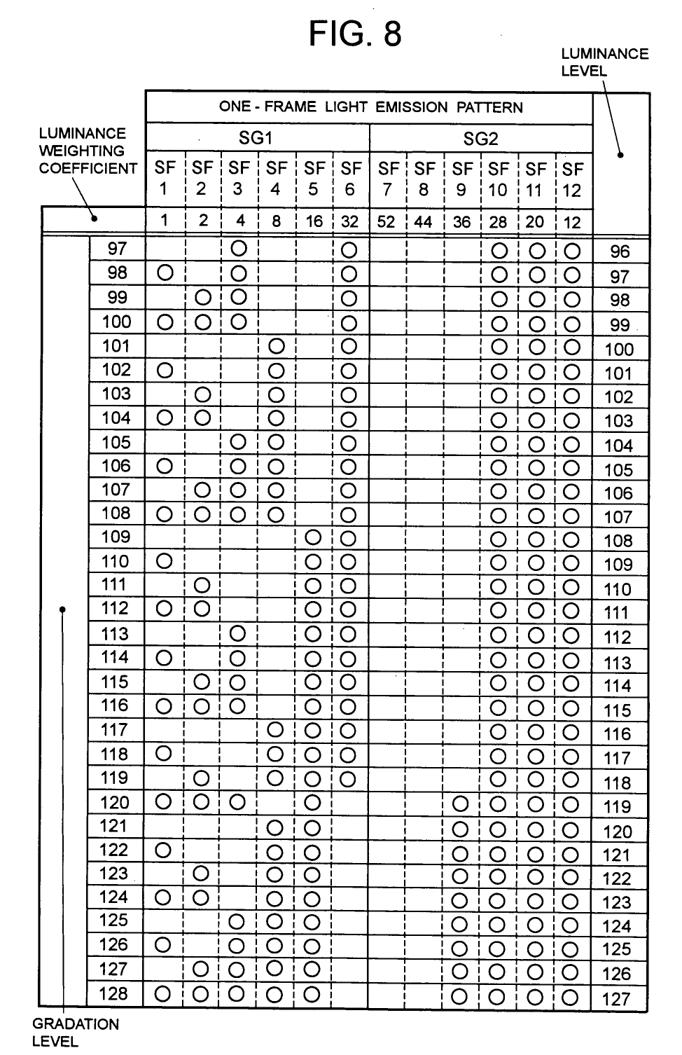

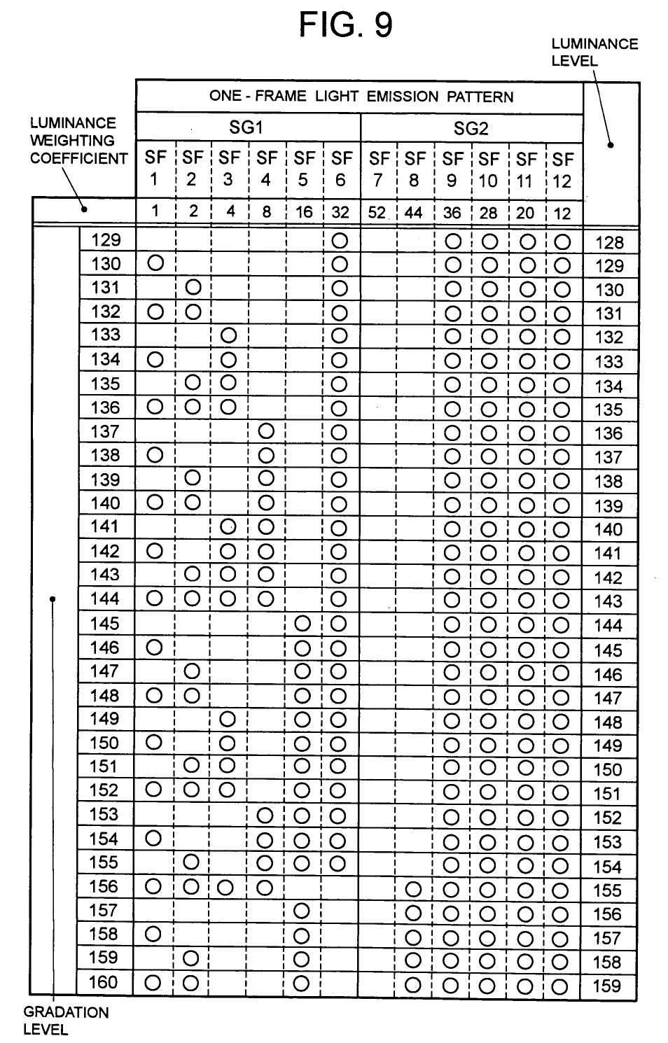

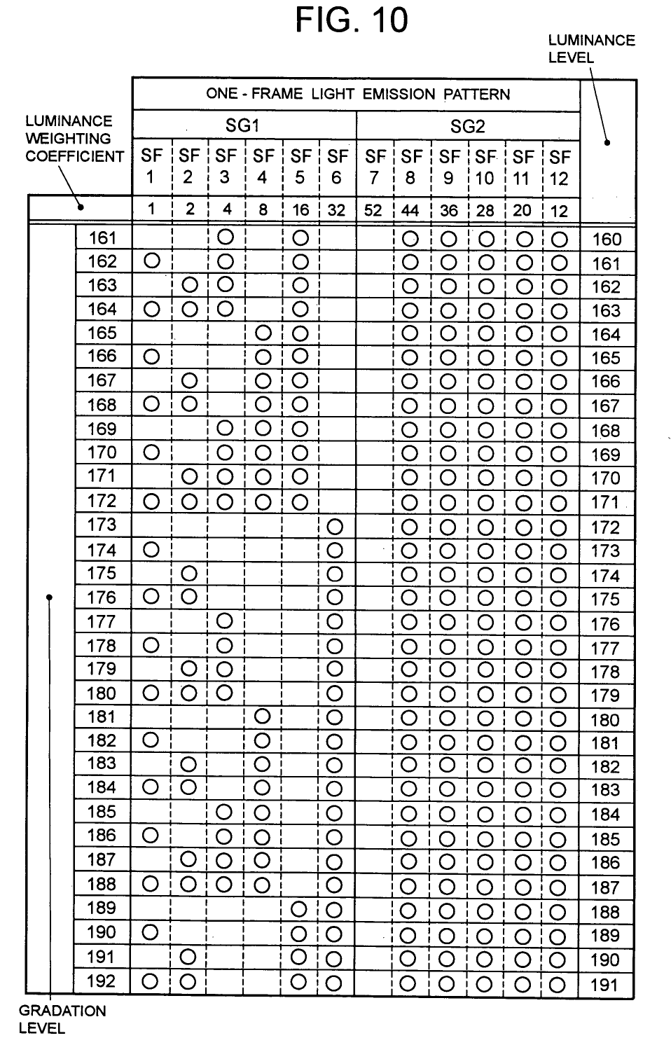

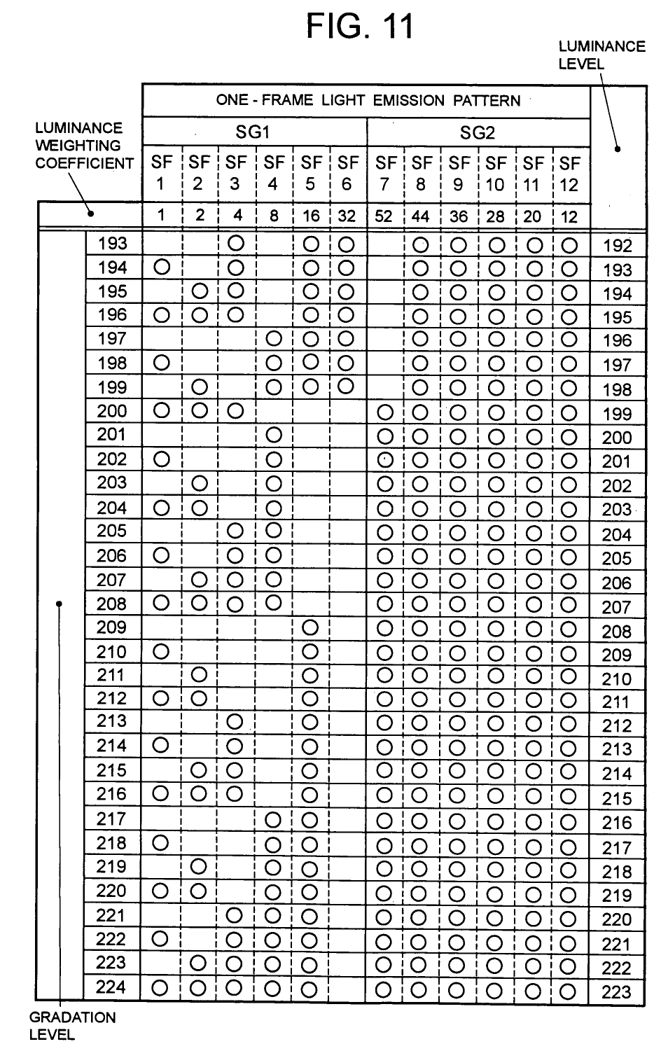

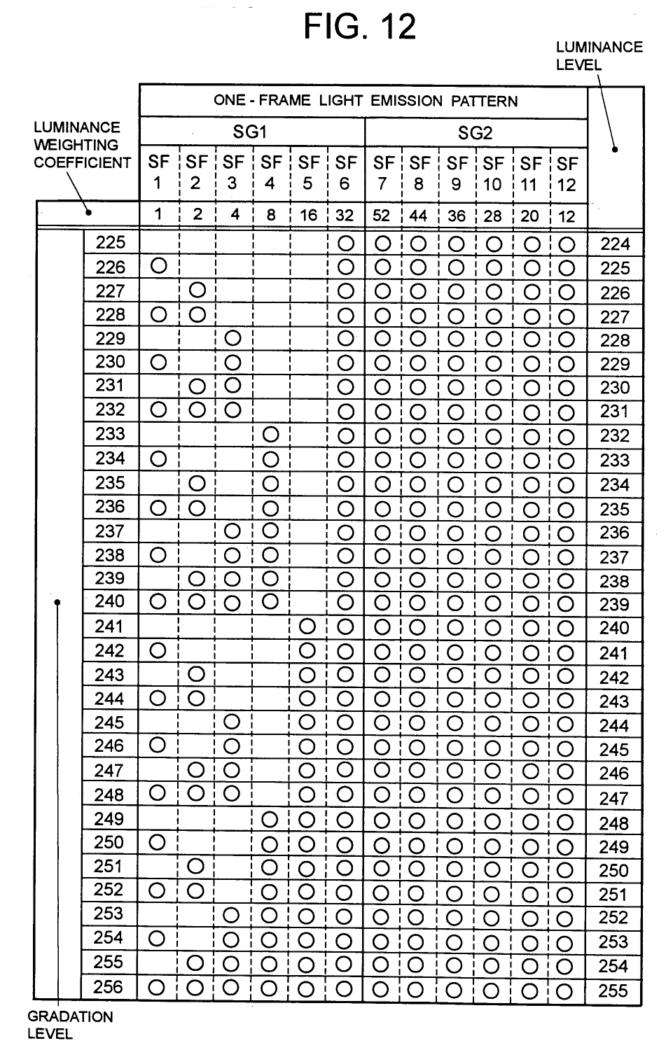

FIGS. 5 to 12 are diagrams showing light emission driving patterns in one frame display period when the panel driving section drives the PDP 10 in accordance with a luminance level indicated by an input video signal based on the light emission driving sequence shown in FIG. 4.

In FIGS. 5 to 12, in a sub-field SF marked with a white circle, discharge cells are set to the light emitting mode. In other words, in this sub-field, the discharge cells emit light over a period corresponding to the luminance weighting coefficient assigned to the sub-field, as described above. According to 256 light luminance driving patterns (first to 256th luminance levels) as shown in FIGS. 5 to 12, the luminance can be represented at 256 levels in a range of the lowest luminance level to the highest luminance level, as indicated by an input video signal.

Here, with a combination of light emitting sub-fields (indicated by circles) by the sub-fields SF1-SF6 in the first sub-field group SG1, the luminance lower than a predetermined luminance level can be represented at 59 levels (first to 59th levels of gradation).

The full erasure stage Ec is provided in each of the sub-fields of the first sub-field group SG1 for switching discharge cells from the light emitting mode to the non-light emitting mode, whereas the full erasure stage Ec is provided only in the first sub-field SF7 of the second sub-field group SG2. In other words, it is only the sub-field SF7 which gives an opportunity of switching discharge cells from the light emitting mode to the non-light emitting mode in the second sub-field group SG2. Therefore, once a discharge cell is set to the light emitting mode in any of the sub-fields SF7 to SF12, the discharge cell is subsequently maintained in the light emitting mode until the last sub-field SF12, so that the sustain discharges are produced in succession to emit light in each sub-field.

Therefore, in the second sub-field group SG2, six levels of luminance are represented with the following values of the luminance weighting coefficients:

“12”:light emitted only in SF12;

“32”:light emitted in SF11 and SF12;

“60”:light emitted in SF10-SF12;

“96”:light emitted in SF9-SF12

“140”:light emitted in SF8-SF12; and

“192”:light emitted in SF7-SF12

by six types of light emission patterns in which the discharge cell continues the light emitting state in succession until the last sub-field SF12 once the discharge cell has transitioned to the light emitting state, such as:

light emitted only in SF12;

light emitted in each of SF11 and SF12;

light emitted in each of SF10-SF12;

light emitted in each of SF9-SF12;

light emitted in each of SF8-SF12; and

light emitted in each of SF7-SF12.

Therefore, luminance levels higher than the predetermined luminance level are represented at 197 levels (60th to 256th levels) by a combination of the light emission patterns for the six levels of gradation in the second sub-field section SG2, as described above, with the light emission patterns for the 59 levels of gradation in the first sub-field group SG1.

Here, a spurious border appears prominent particularly at locations at which sub-fields with large luminance weighting coefficients are arranged. In this event, in the second sub-field group SG2, there are arranged sub-fields with large luminance weighting coefficients which make the spurious border prominent. However, since there is no combination of light emission patterns which present an inversion of a discharge cell from a light emitting period to a non-light emitting period and vice versa in one field period, the spurious border is suppressed.

Further, according to the foregoing driving technique, the luminance can be represented at 256 levels in the 12 sub-fields SF1-SF12 by a combination of the driving sequences in the second sub-field group SG2 with the driving sequences in the first sub-field group SG1.

The foregoing embodiment has been described for the case where the so-called selective write addressing method is employed for selectively forming a wall charge in each discharge cell in accordance with pixel data in driving the PDP 10 based on the sub-field method. However, the present invention can be similarly applied to a driving sequence which employs the so-called selective erasure addressing method which involves previously forming wall charges in all discharge cells and selectively erasing the wall charges which remain in the discharge cells in accordance with pixel data.

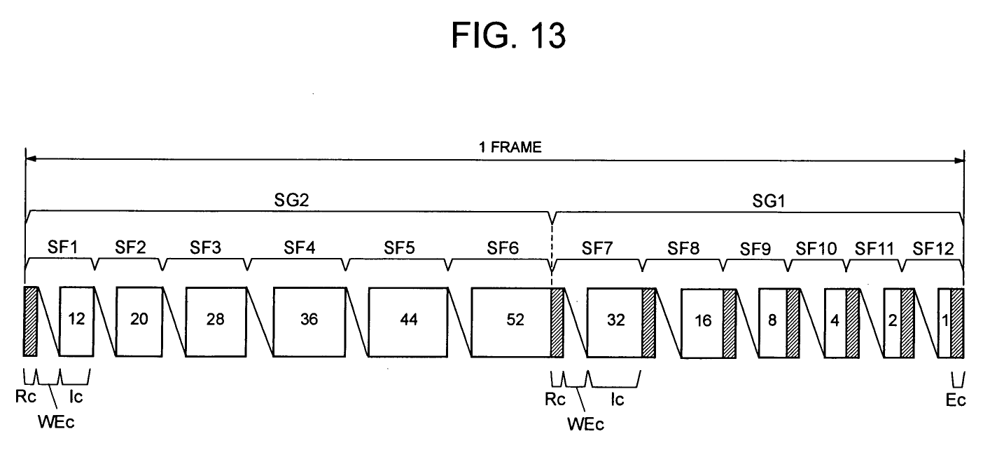

FIG. 13 is a diagram showing a light emission driving sequence when the selective erasure addressing method is employed to drive the PDP 10.

In the light emission driving sequence shown in FIG. 13, the following luminance weighting coefficients are applied to the sub-fields SF1-SF12, respectively:

SF1: 12

SF2: 20

SF3: 28

SF4: 36

SF5: 44

SF6: 52

SF7: 32

SF8: 16

SF9: 8

SF10: 4

SF11: 2

SF12: 1

In this event, the sub-fields SF1-SF6 belonging to a second sub-field group SG2 are arranged in the former half of one frame display period for emitting light of high luminance components, as shown in FIG. 13. Specifically, in the second sub-field group SG2, the respective sub-fields are arranged in the order of SF1, SF2, SF3, SF4, SF5, and SF6 which has the largest value of the luminance weighting coefficient, such that the values of the luminance weighting coefficients assigned to the respective sub-fields increase “eight” by “eight.” On the other hand, in the latter half of one frame display period, sub-fields SF6-SF12 belonging to a first sub-field group SG1 are arranged for emitting light of high luminance components, as shown in FIG. 13. Specifically, in the first sub-field group SG1, the respective sub-fields are arranged such that the values of the luminance weighting coefficients assigned to the respective sub-fields decrease in a form of geometric series with a common ratio set to 1/2, that is, the values increase in a form of geometric series with a common ratio set to two from the last one toward the front.

Also, in the light emission driving sequence shown in FIG. 13, the panel driving section executes a selective erasure addressing stage WEc and a sustain stage Ic, respectively, in each of the sub-fields SF1-SF6 which belong to the second sub-field group SG2. The panel driving section executes a reset stage Rc only in the first sub-field SF1 of the second sub-field group SG2 prior to the selective erasure addressing stage WEc. On the other hand, the panel driving section executes the reset stage Rc, selective erasure addressing stage WEc, and sustain stage Ic, respectively, in each of the sub-fields SF7-SF12 which belong to the first sub-field group SG1. The panel driving section executes a full erasure stage Ec only in the last sub-field SF12 of the first sub-field group SG1 after the sustain stage Ic.

In the reset stage Rc, the panel driving section forces all the discharge cells of the PDP 10 to simultaneously produce a reset discharge to form a predetermined amount of wall charges in all the discharge cells. With the reset discharge, all the discharge cells are forcedly initialized to the light emitting mode.

In the selective erasure addressing stage WEc, the panel driving section selectively forces only those discharge cells which are specified in the non-light emitting mode to produce an erasure address discharge based on the pixel driving data. In this event, a predetermined amount of wall charge remaining in each of the discharge cells is erased to set the discharge cell to the non-light emitting mode. Discharge cells which are not forced to produce the erasure address discharge are maintained in a current mode (light emitting mode or non-light emitting mode).

In the sustain stage Ic, the panel driving section forces only those discharge cells set in the light emitting mode to repeatedly produce sustain discharges over a period (or a number of times) corresponding to the luminance weighting coefficient of the sub-field to maintain the light emitting state associated with the discharge.

In the full erasure stage Ec, the panel driving section forces all the discharge cells of the PDP 10 to simultaneously produce an erasure discharge to leave the amount of wall charges in all the discharge cells equal to or less than a predetermined amount. With the erasure discharge, all the discharge cells are forcedly set to the non-light emitting mode.

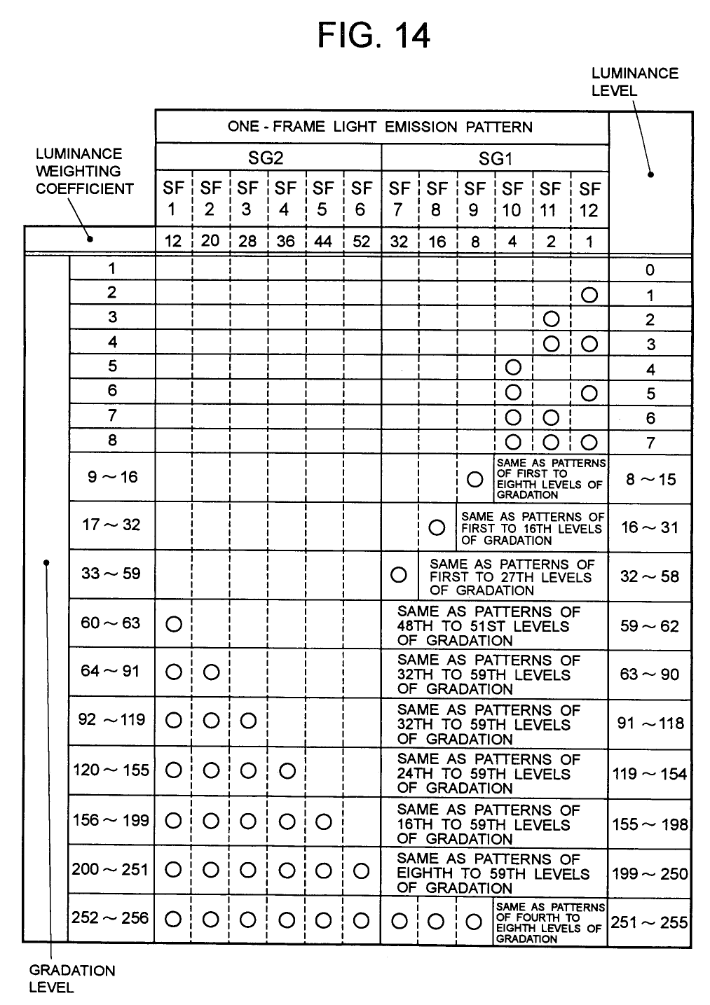

FIG. 14 is a diagram showing light emission driving patterns in one frame display period when the panel driving section drives the PDP 10 in accordance with a luminance level indicated by an input video signal based on the light emission driving sequence shown in FIG. 13.

In FIG. 14, in a sub-field SF marked with a white circle, the discharge cells are set to the light emitting mode, so that the discharge cells emit light over a period corresponding to the luminance weighting coefficient as described above in this sub-field. Specifically, in the driving sequence which employs the selective erasure addressing method as shown in FIGS. 13 and 14, the sub-fields SF1-SF6 belonging to the first sub-field group SG1 in FIG. 4 are reversed in the order in which they are arranged, and the resulting sub-fields are designated SF7-SF12, which are placed in the latter half of one frame display period. Further, the sub-fields SF7-SF12 belonging to the second sub-field group SG2 in FIG. 4 are reversed in the order in which they are arranged, and the resulting sub-fields are designated SF1-SF6, which are placed in the former half of one frame display period. According to 256 light emission driving patterns (first to 256th levels of gradation) as shown in FIG. 14, each of various luminance levels in the range of the lowest luminance level to the highest luminance level indicated by an input video signal can be represented at 256 levels of gradation.

In this case, with a combination of light emitting sub-fields (indicated by circles) by the sub-fields SF7-SF12 in the first sub-field group SG1, the luminance lower than a predetermined luminance level can be represented at 59 levels (first to 59th levels of gradation).

The reset stage Rc is provided in each of the sub-fields belonging to the first sub-field group SG1 for switching discharge cells from the non-light emitting mode to the light emitting mode, whereas the reset stage Rc is provided only for the first sub-field SF1 in the second sub-field group SG2. In other words, it is only the sub-field SF1 which gives an opportunity of switching discharge cells from the non-light emitting mode to the light emitting mode in the second sub-field group SG2. Therefore, once a discharge cell is set to the non-light emitting mode in any of the sub-fields SF1 to SF6, the discharge cell is subsequently maintained in the non-light emitting mode until the last sub-field SF6, so that the sustain discharges are produced in succession to emit light in each sub-field.

Therefore, in the second sub-field group SG2, six levels of luminance are represented with the values of the following luminance weighting coefficients:

“12”:light emitted only in SF1;

“32”:light emitted in SF1 and SF2;

“60”:light emitted in S1-SF3;

“96”:light emitted in SF1-SF4

“140”:light emitted in SF1-SF5; and

“192”:light emitted in SF1-SF6

by six types of light emission patterns in which the discharge cell continues the non-light emitting state in succession until the last sub-field SF6 once the discharge cell has transitioned to the non-light emitting state, such as:

light emitted only in SF1;

light emitted in each of SF1 and SF2;

light emitted in each of SF1-SF3;

light emitted in each of SF1-SF4;

light emitted in each of SF1-SF5; and

light emitted in each of SF1-SF6.

With the driving patterns shown in FIG. 14, luminance levels higher than the predetermined luminance level are represented at 197 levels (60th to 256th levels) by a combination of the light emission patterns for the six levels of gradation in the second sub-field section SG2 with the light emission patterns for the 59 levels of gradation in the first sub-field group SG1.

In this event, there is no combination of light emission patterns which present the inversion of a discharge cell from a light emitting period to a non-light emitting period and vice versa in the six types of light emission patterns implemented in the second sub-field group SG2 in which the spurious borders are relatively prominent. Therefore, when the selective erasure addressing method is employed to drive the PDP 10 to display a halftone image, it is also possible to represent 256 levels of luminance with 12 sub-fields SF1-SF12 while suppressing the spurious borders, in a manner similar to the driving technique which employs the selective write addressing method.

As described above, in the driving techniques shown in FIGS. 4 to 12 or FIGS. 13 and 14, the first sub-field group (first sub-field group SG1) and second sub-field group (second sub-field group SG2) are included in one frame display period. In this event, in the first sub-field group, a plurality of sub-fields are arranged in sequence such that the values of luminance weighting coefficients assigned to the respective sub-fields advance in a form of geometric series with a common ratio set to two, as expressed by:
G(n)=2⁽ⁿ⁻¹⁾
where G: Value of Luminance Weight; and

n: Position of Sub-field in Group.

On the other hand, in the second sub-field group, a plurality of sub-fields are arranged in sequence such that the sub-field assigned the largest luminance weighting coefficient is included and the values of luminance weighting coefficients assigned to the respective sub-fields advance in a form of arithmetic series as expressed by:
G(n)=a+(n-1)·d
where G: Value of Luminance Weight;

n: Position of Sub-field in Group;

a: Initial Value of Luminance Weight; and

d: Predetermined Value.

Then, the second sub-field group is arranged such that the sub-field (SF7, SF6) assigned the largest luminance weighting coefficient is placed at a position other than the head and tail of one frame display period.

With the foregoing technique, multiple levels of luminance can be represented with a small number of sub-fields while suppressing the spurious borders.

### Second Embodiment

When a γ correction is applied to an input video signal, a plasma display panel device must apply an inverse γ correction to the input video signal to release the γ correction.

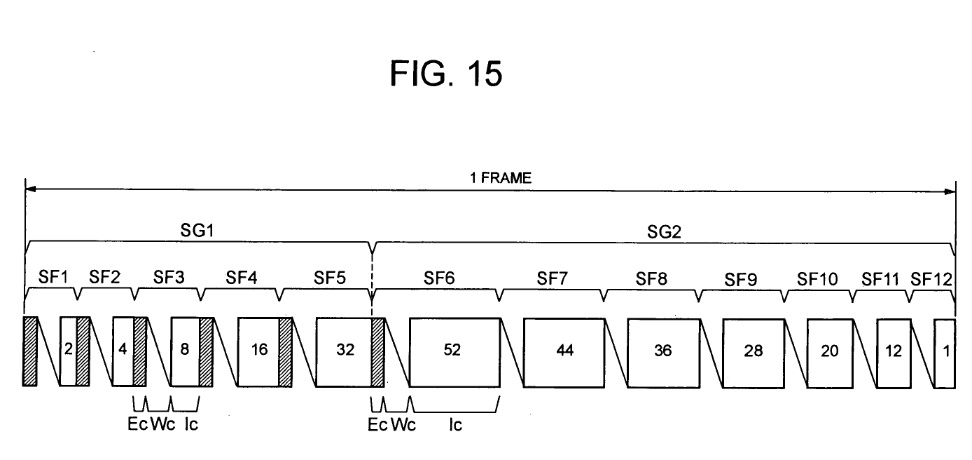

FIG. 15 is a diagram showing another example of a light emission driving sequence based on the selective write addressing method which also includes the inverse γ correction processing.

In the light emission driving sequence shown in FIG. 15, luminance weighting coefficients are applied to the sub-fields SF1-SF12, respectively, as follows:

SF1: 2

SF2: 4

SF3: 8

SF4: 16

SF5: 32

SF6: 52

SF7: 44

SF8: 36

SF9: 28

SF10: 20

SF11: 12

SF12: 1

Specifically, the sub-field assigned luminance weighting coefficient “1” placed at the head of one frame display period in the light emission driving sequence of FIG. 4 is moved to the tail of one frame display period. Further, in the light emission driving sequence shown in FIG. 15, sub-fields SF1-SF5 belong to the first sub-field group SG1 in the former half of one frame display period, while sub-fields SF6-SF12 belong to the second sub-field group SG2 in the latter half of one frame display period.

In each of the sub-fields SF1-SF5 belonging to the first sub-field group SG1, the panel driving section executes the full erasure stage Ec, selective write addressing stage Wc, and sustain stage Ic, respectively. On the other hand, in each of the sub-fields SF6-SF12 belonging to the second sub-field group SG2, the panel driving section executes the selective write stage Wc and sustain stage Ic, respectively. The panel driving section executes the full erasure stage Ec only for the first sub-field SF6 in the second sub-field group SG2 prior to the selective write addressing stage Wc.

In this event, since the operations in the full erasure stage Ec, selective write addressing stage Wc, and sustain stage Ic are the same as those described in connection with FIG. 4, description thereon is omitted.

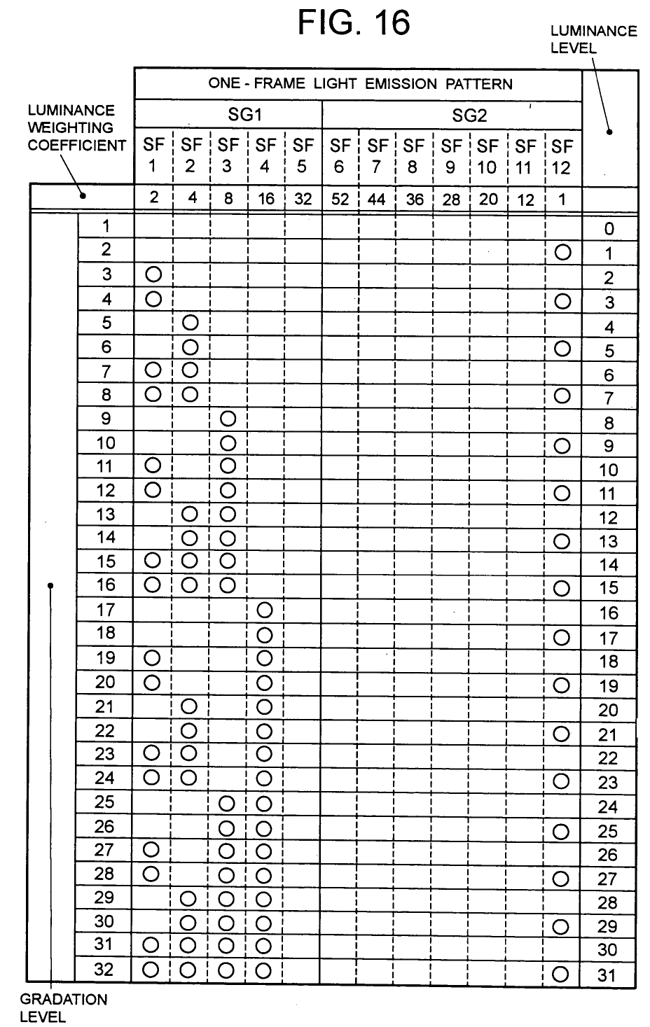

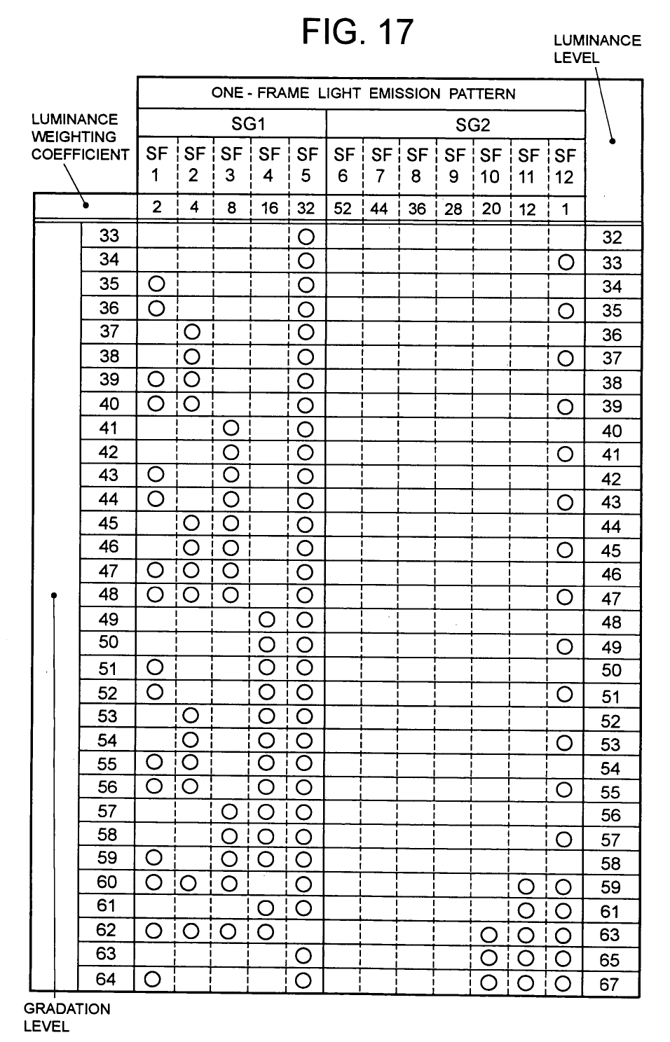

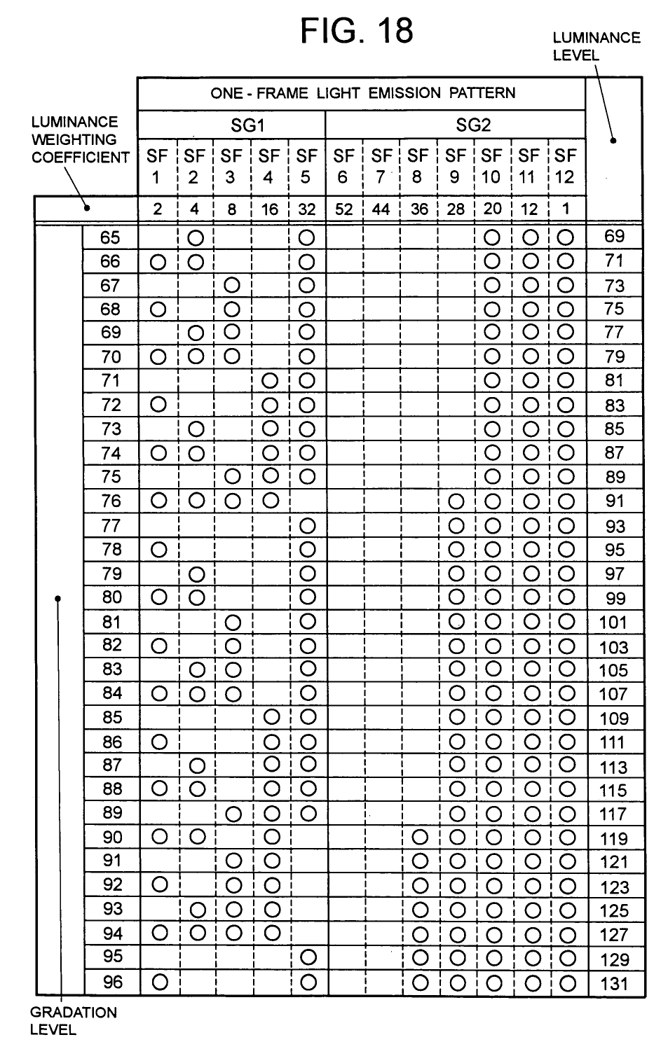

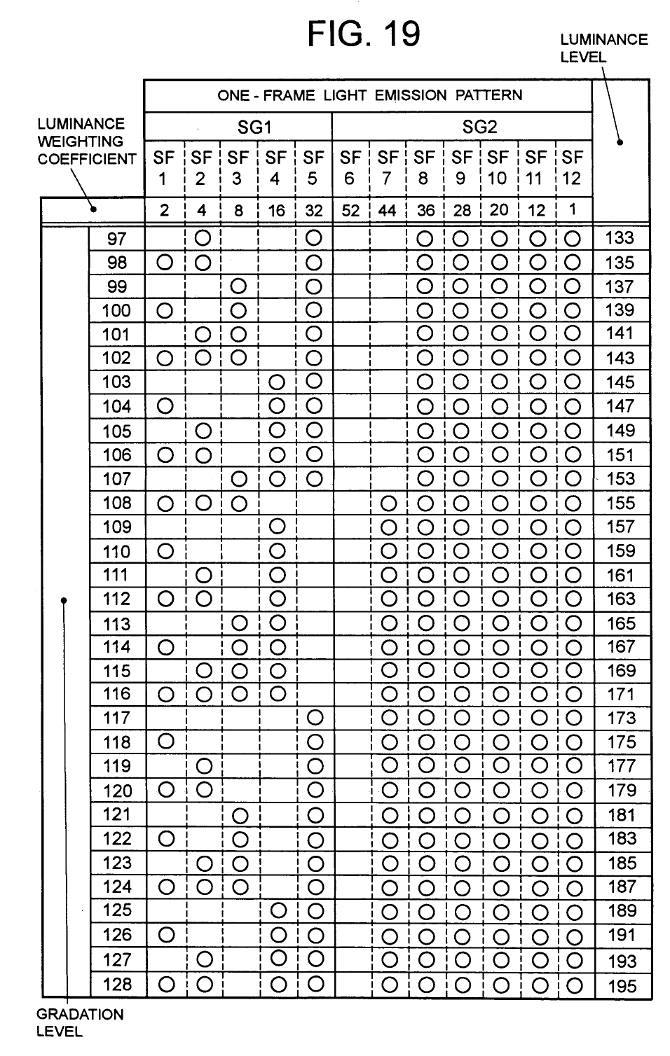

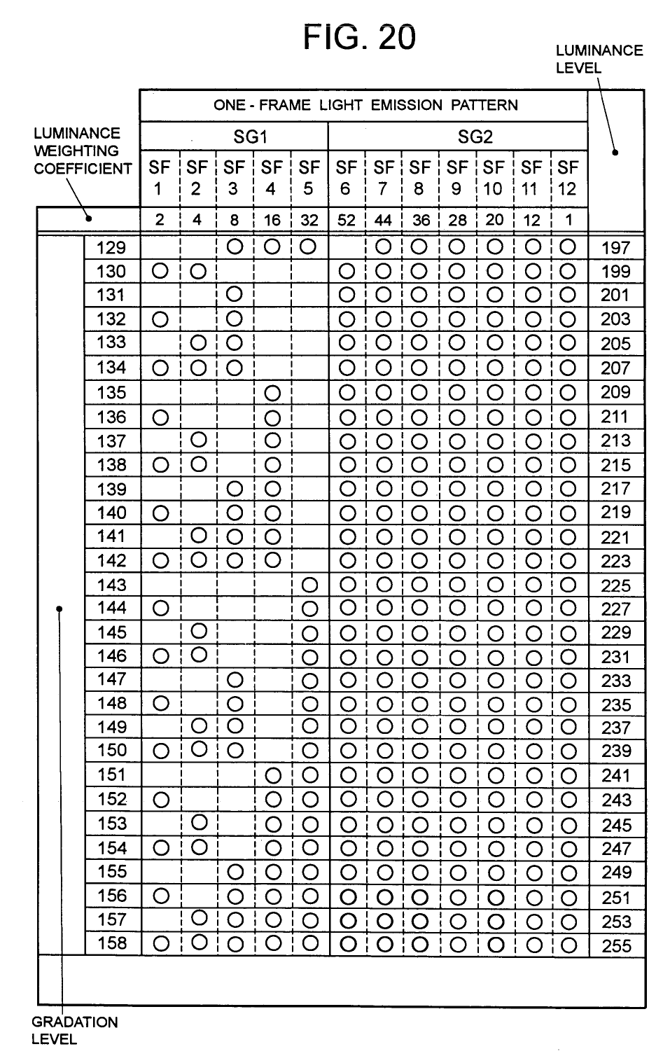

FIG. 16 to 20 are diagrams showing light emission patterns in one frame display period when the panel driving section drives the PDP 10 in accordance with a luminance level indicated by an input video signal based on the light emission driving sequence shown in FIG. 15.

In the driving technique shown in FIGS. 15 to 20, with a combination of light emitting sub-fields (indicated by circles) by the sub-fields SF1-SF5 in the first sub-field group SG1 and SF12 belonging to the second sub-field group SG2, the luminance lower than a predetermined luminance level is represented at 59 levels (first to 59th levels of gradation).

Here, in the light emission driving sequence shown in FIG. 15, the full erasure stage Ec is provided in each of the sub-fields of the first sub-field group SG1 in a manner similar to that shown in FIG. 4. However, the full erasure stage Ec is provided only for the first sub-field SF6 in the second sub-field group SG2. In other words, it is only the sub-field SF6 which gives an opportunity of switching discharge cells from the light emitting mode to the non-light emitting mode in the second sub-field group SG2. Therefore, once a discharge cell is set to the light emitting mode in any of the sub-fields SF6 to SF12, the discharge cell is subsequently maintained in the light emitting mode until the last sub-field SF12, so that the sustain discharges are produced in succession to emit light in each sub-field.

Therefore, in the second sub-field group SG2, seven levels of luminance are represented with the values of the following luminance weighting coefficients:

“1”:light emitted only in SF12;

“13”:light emitted in SF11 and SF12;

“33”:light emitted in SF10-SF12;

“61”:light emitted in SF9-SF12

“97”:light emitted in SF8-SF12;

“141”:light emitted in SF7-SF12; and

“193”:light emitted in SF6-SF12

by six types of light emission patterns in which the discharge cell continues the light emitting state in succession until the last sub-field SF12 once the discharge cell has transitioned to the light emitting state, such as:

light emitted only in SF12;

light emitted in each of SF11 and SF12;

light emitted in each of SF10-SF12;

light emitted in each of SF9-SF12;

light emitted in each of SF8-SF12; and

light emitted in each of SF7-SF12.

In this event, as shown in FIGS. 16 to 20, for emitting light at a luminance higher than a predetermined luminance level (59th level of gradation), a light emission only in the sub-field SF12 is not performed in the second sub-field group SG2 as mentioned above. Further, for emitting light at a luminance higher than the predetermined luminance level, the light is emitted at 26 levels of gradations with 26 light emission patterns in the first sub-field group SG1. Therefore, in the driving patterns shown in FIGS. 16 to 20, high luminance levels are represented at 99 levels of gradation (60th to 158th) with a combination of the light emission patterns for the six levels of gradation in the second sub-field group SG2 with the light emission patterns for the 26 levels of gradation in the first sub-field group SG1. In other words, when an input video signal can represent luminance levels “0”-“255,” low luminance components at luminance levels from “0” to “58” are represented at 59 levels (first to 59th levels of gradation) in increments of luminance level “1.” On the other hand, a high luminance range at luminance levels from “59” to “255” is represented at 99 levels (60th to 158th levels of gradation) in increments of luminance level “2.”

Stated another way, in the driving patterns shown in FIGS. 15 to 20, a luminance level difference is increased when a luminance higher than a predetermined luminance level is represented as compared with when a lower luminance is represented, looking to the fact that the luminance level difference increases between adjacent luminance levels as a luminance level to be represented is higher in the inverse γ correction.

In the driving technique shown in FIGS. 15 to 20, there is no combination of light emission patterns which present the inversion of a discharge cell from a light emitting period to a non-light emitting period and vice versa in the six types of light emission patterns implemented in the second sub-field group SG2 which includes sub-fields arranged with large luminance weights assigned thereto. Also, 158 levels of luminance are represented with 12 sub-fields SF1-SF12 by combining the driving patterns in the second sub-field group SG2 with the driving patterns in the first sub-field group SG1. Therefore, it is also possible to represent 256 levels of luminance with 12 sub-fields SF1-SF12 while suppressing the spurious borders in the driving technique shown in FIGS. 15 to 20, in a manner similar to the driving technique shown in FIGS. 4 to 12.

While FIGS. 15 to 20 show the operation when the selective write addressing method is employed to drive the PDP 10, this may be executed using the selective erasure addressing method.

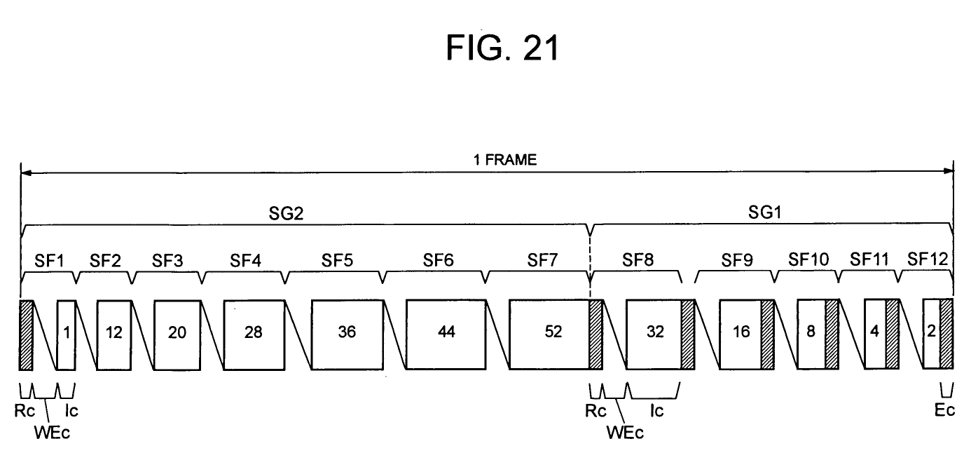

FIG. 21 is a diagram showing a light emission driving sequence when the selective erasure addressing method is employed to drive the PDP 10 in consideration of the inverse γ correction.

In the light emission driving sequence shown in FIG. 21, the following luminance weighting coefficients are applied to the sub-fields SF1-SF12, respectively:

SF1: 1

SF2: 12

SF3: 20

SF4: 28

SF5: 36

SF6: 44

SF7: 52

SF8: 32

SF9: 16

SF10: 8

SF11: 4

SF12: 2

In this event, the sub-fields SF1-SF7 belonging to a second sub-field group SG2 are arranged in the former half of one frame display period, as shown in FIG. 21. Specifically, in the second sub-field group SG2, the respective sub-fields are arranged in the order of SF1, SF2, SF3, SF4, SF5, SF6, SF7, such that the luminance weighting coefficients assigned thereto increase from the head to the tail. On the other hand, in the latter half of one frame display period, sub-fields SF8-SF12 belonging to a first sub-field group SG1 are arranged for emitting light of low luminance components, as shown in FIG. 21. Specifically, in the first sub-field group SG1, the respective sub-fields are arranged such that the luminance weighting coefficients assigned to the respective sub-fields decrease in a form of geometric series with a common ratio set to 1/2, that is, the luminance weighting coefficients increase in a form of geometric series with a common ratio set to two from the tail toward the front.

In the light emission driving sequence shown in FIG. 21, the panel driving section executes the selective erasure addressing stage WEc and sustain stage Ic, respectively, in each of the sub-fields SF1-SF7 which belong to the second sub-field group SG2. The panel driving section executes the reset stage Rc only for the first sub-field SF1 in the second sub-field group SG2 prior to the selective erasure addressing stage WEc. On the other hand, the panel driving section executes the reset stage Rc, selective erasure addressing stage WEc, and sustain stage Ic, respectively, in each of the sub-fields SF8-SF12 which belong to the first sub-field group SG1. The panel driving section executes the full erasure stage Ec only for the last sub-field SF12 in the first sub-field group SG1 after the sustain stage Ic.

Since the operations in the reset stage Rc, selective erasure addressing stage WEc, sustain stage Ic, and full erasure stage Ec are the same as those described in connection with FIG. 13, description thereon is omitted.

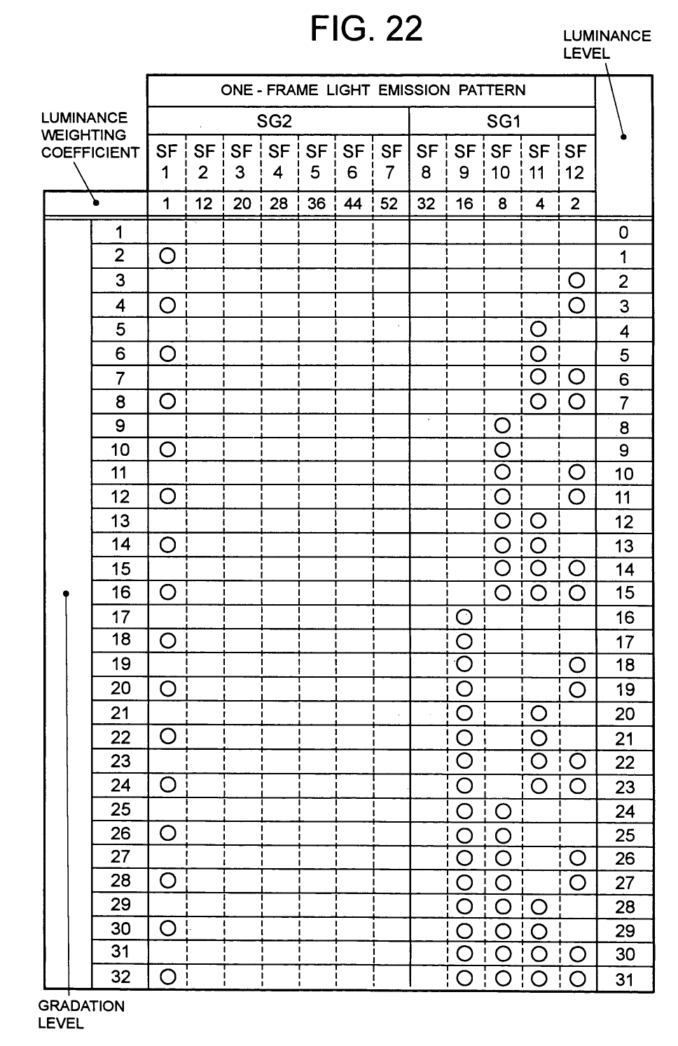

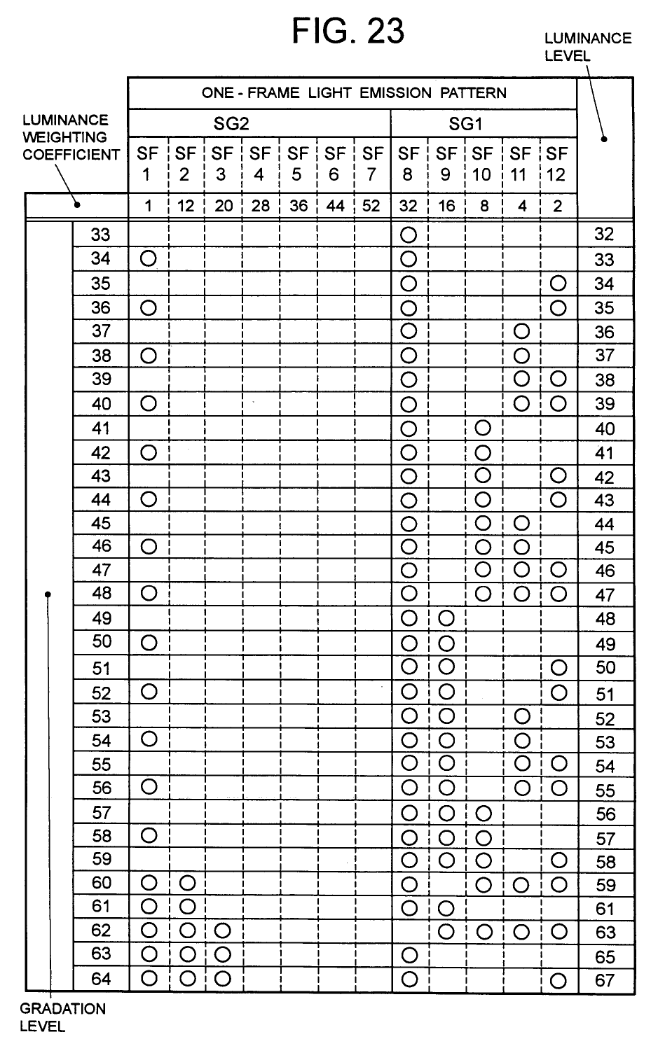

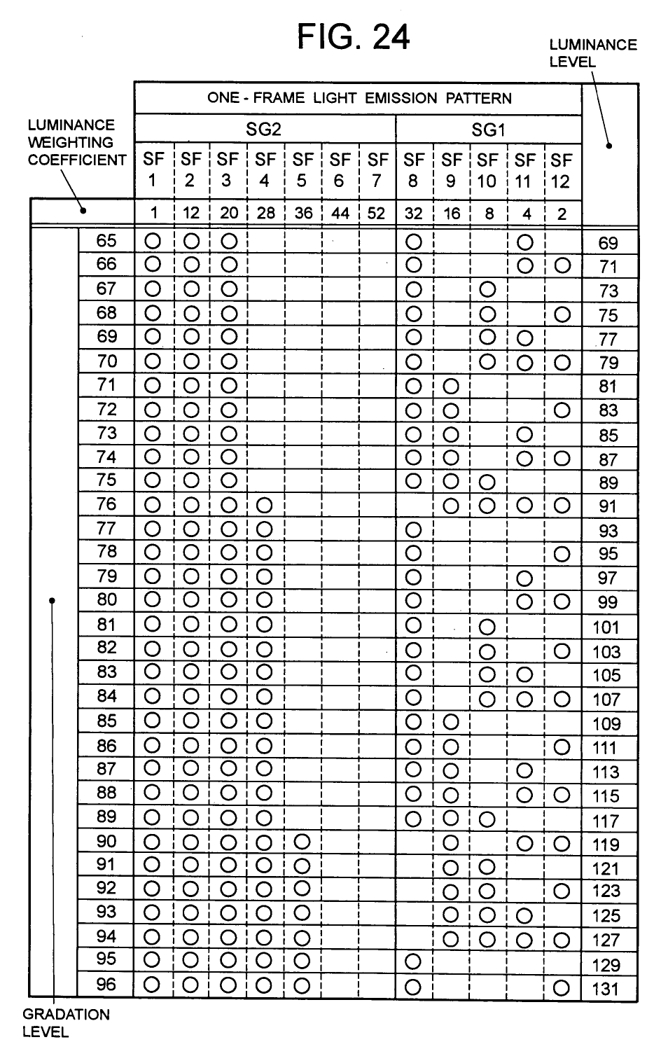

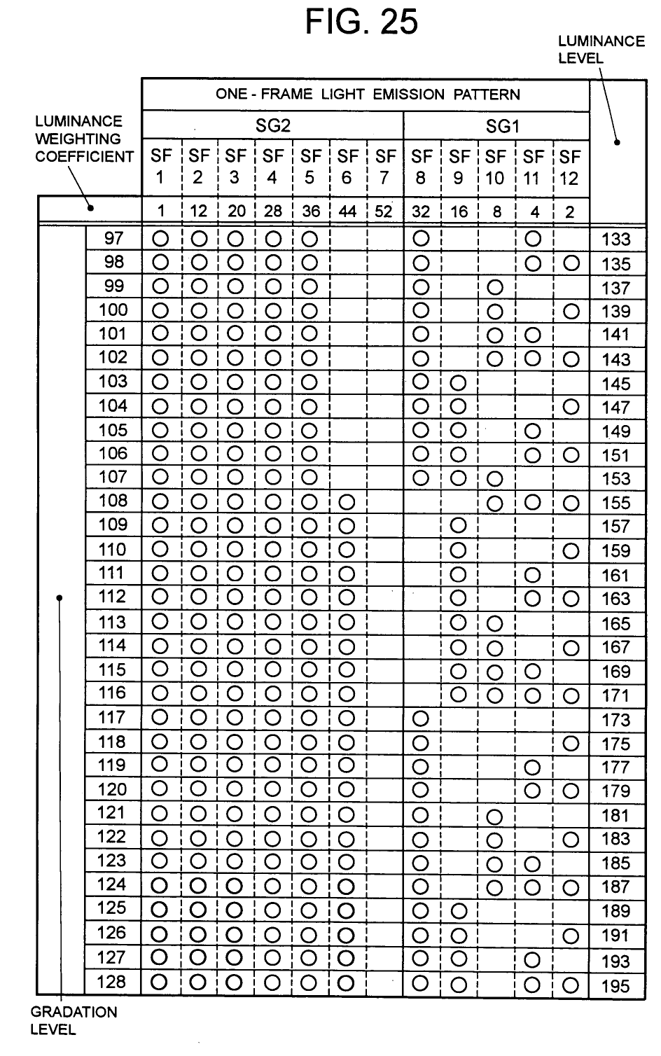

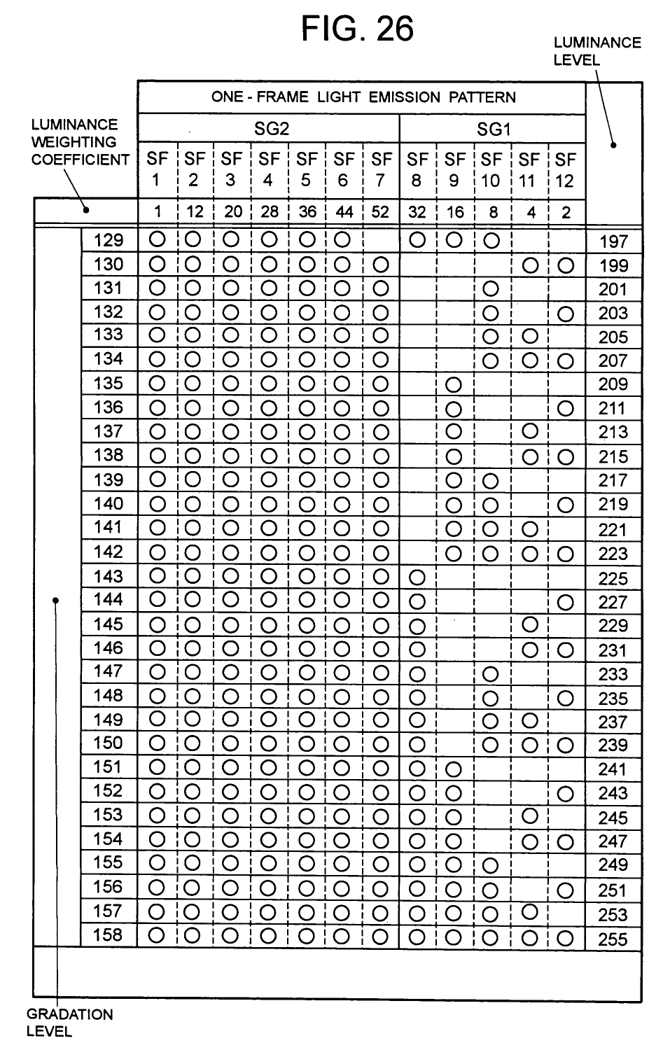

FIG. 22 to 26 are diagrams showing light emission patterns in one frame display period when the panel driving section drives the PDP 10 in accordance with a luminance level indicated by an input video signal based on the light emission driving sequence shown in FIG. 21.

In FIGS. 22 to 26, in a sub-field SF marked with a white circle, discharge cells are set to the light emitting mode, so that the discharge cells emit light over a period corresponding to the luminance weighting coefficient as described above in this sub-field. Specifically, in the driving sequence which employs the selective erasure addressing method as shown in FIGS. 21 to 26, the sub-fields SF1-SF5 belonging to the first sub-field group SG1 in FIG. 15 are reversed in the order in which they are arranged, and the resulting sub-fields are designated SF8-SF12, which are placed in the latter half of one frame display period. Further, the sub-fields SF6-SF12 belonging to the second sub-field group SG2 in FIG. 15 are reversed in the order in which they are arranged, and the resulting sub-fields are designated SF1-SF7, which are placed in the former half of one frame display period. According to 158 light emission driving patterns (first to 158th levels of gradation) as shown in FIGS. 22 to 26, each of various luminance levels in the range of the lowest luminance level to the highest luminance level indicated by an input video signal can be represented at 256 levels of gradation, in a manner similar to the driving patterns which employ the selective write addressing method as shown in FIGS. 15 to 20. In this event, with a combination of light emitting sub-fields (indicated by circles) by the sub-fields SF8-SF12 in the first sub-field group SG1, a lower luminance range is represented at 59 levels (first to 59th levels of gradation). The reset stage Rc is provided in each of the sub-fields of the first sub-field group SG1, whereas the reset stage Rc is provided only for the first sub-field SF1 in the second sub-field group SG2. In other words, it is only the sub-field SF1 which gives an opportunity of switching discharge cells from the non-light emitting mode to the light emitting mode in the second sub-field group SG2. Therefore, once a discharge cell is set to the non-light emitting mode in any of the sub-fields SF1 to SF7, the discharge cell is subsequently maintained in the non-light emitting mode until the last sub-field SF7, so that the sustain discharges are produced in succession to emit light in each sub-field.

Therefore, in the second sub-field group SG2, seven levels of luminance are represented with the values of the following luminance weighting coefficients:

“1”:light emitted only in SF1;

“13”:light emitted in SF1 and SF2;

“33”:light emitted in S1-SF3;

“61”:light emitted in SF1-SF4

“97”:light emitted in SF1-SF5;

“141”:light emitted in SF1-SF6; and

“193”:light emitted in SF1-SF7

by seven types of light emission patterns in which the discharge cell continues the light emitting state in succession from the first sub-field SF1, and subsequently continues the non-light emitting state until the last sub-field SF7 after the discharge cell has transitioned to the non-light emitting state, such as:

light emitted only in SF1;

light emitted in each of SF1 and SF2;

light emitted in each of SF1-SF3;

light emitted in each of SF1-SF4;

light emitted in each of SF1-SF5;

light emitted in each of SF1-SF6; and

light emitted in each of SF1-SF7.

In this event, as shown in FIGS. 22 to 26, for emitting light at a luminance higher than a predetermined luminance level, a light emission only in the sub-field SF1 is not performed in the second sub-field group SG2 as mentioned above. Further, in the sub-field group SG1, the light emission is driven over 26 levels of gradation with 26 light emission patterns. Therefore, for emitting light at a luminance higher than the predetermined luminance level (59th level of gradation), the luminance level is represented at 99 levels of gradation (60th to 158th) with a combination of the light emission patterns for the six levels of gradation in the second sub-field group SG2 with the light emission patterns for the 26 levels of gradation in the first sub-field group SG1. In other words, when an input video signal can represent luminance levels “0”-“255,” low luminance components at luminance levels from “0” to “58” are represented at 59 levels (first to 59th levels of gradation) in increments of luminance level “1.” On the other hand, a high luminance range at luminance levels from “59” to “255” is represented at 99 levels (60th to 158th levels of gradation) in increments of luminance level “2.” In this event, there is no combination of light emission patterns which present the inversion of a discharge cell from a light emitting period to a non-light emitting period and vice versa in the six types of light emission patterns in the second sub-field group SG2 which includes sub-fields arranged with large luminance weighting coefficients assigned thereto so that spurious borders are relatively prominent. Therefore, it is also possible to represent 158 levels of luminance with 12 sub-fields SF1-SF12 while suppressing the spurious borders when the selective erasure addressing method is employed to drive the PDP 10 to display a half-tone image, as is the case with the driving technique which employs the selective write addressing method.

While the driving sequences shown in FIGS. 15 and 21 divide one frame display period into the first sub-field group SG1 and second sub-field group SG2, these SG1 and SG2 may be each sub-divided into two such that the resulting sub-field groups are distributively arranged in one frame display period.

### Third Embodiment

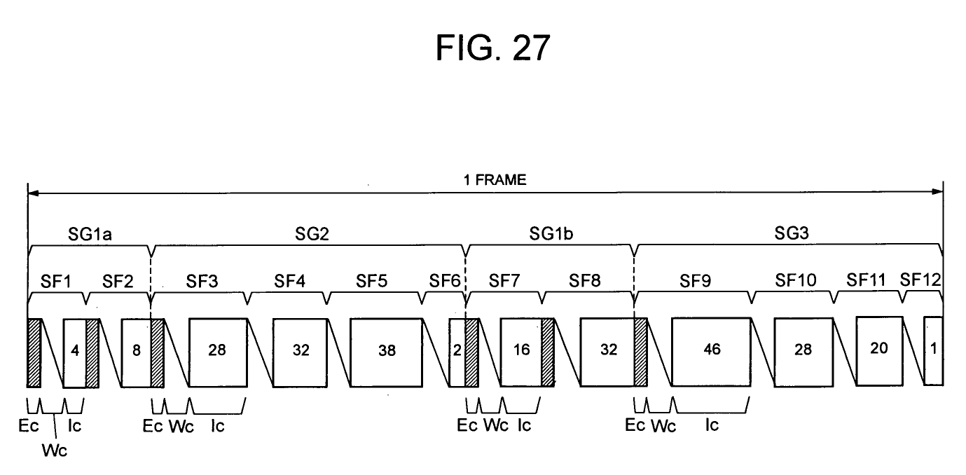

FIG. 27 is a diagram showing an example of a light emission driving sequence based on the selective write addressing method, which is created in view of the foregoing modification.

In the light emission driving sequence shown in FIG. 27, luminance weighting coefficients are applied to the sub-fields SF1-SF12, respectively, as follows:

SF1: 4

SF2: 8

SF3: 28

SF4: 32

SF5: 38

SF6: 2

SF7: 16

SF8: 32

SF9: 46

SF10: 28

SF11: 20

SF12: 1

In this event, the sub-fields SF1 and SF2 belonging to a first divided sub-field group SG1a for emitting light of low luminance components and sub-fields SF3-SF6 belonging to a second sub-field group SG2 for emitting light of high luminance components are arranged in the former half of one frame display period, as shown in FIG. 27. On the other hand, the sub-fields SF7 and SF8 belonging to a first divided sub-field group SG1b for emitting light of low luminance components, and the sub-fields SF9-SF12 belonging to a third sub-field group SG3 for emitting light of high luminance components are arranged in the latter half of one frame display period.

Specifically, in the first divided sub-field group SG1a, the SF1 and SF2 are arranged such that the values of the luminance weighting coefficients assigned thereto increase from the head to the tail in a form of geometric series with a common ratio set to two. In the first divided sub-field group SG1b, the SF7 and SF8 are arranged such that the values of the luminance weighting coefficients assigned thereto increase from the head to the tail in a form of geometric series with a common ratio set to two. In the second sub-field group GS2, SF3, SF4, SF5 are arranged such that the values of their luminance weighting coefficients increase from the head in order, with the sub-field SF6 having the second smallest luminance weighting coefficient placed at the end. In the third sub-field group SG3, in turn, SF9, SF10, SF11 are arranged such that the values of their luminance weighting coefficients decrease from the head in order, with the sub-field SF12 having the smallest luminance weighting coefficient placed at the end.

In the foregoing arrangement, the sub-field SF9 having the largest luminance weighting coefficient and SF5 having the next largest luminance weighting coefficient are distributively placed in the former half and latter half of one frame display period, respectively. Further, the sub-field SF12 having the smallest luminance weighting coefficient, SF6 having the next smallest luminance weighting coefficient, and SF1 having the third smallest luminance weighting coefficient are placed at the end, at the center, and at the head of one frame display period, respectively.

Here, in each of sub-fields SF1 and SF2 belonging to the first divided sub-field group SG1a, the panel driving section executes the full erasure stage Ec, selective write addressing stage Wc, and sustain stage Ic, respectively. Also, in each of the sub-fields SF7 and SF8 belonging to the first divided sub-field group SG1b, the panel driving section executes the full erasure stage Ec, selective write addressing stage Wc, and sustain stage Ic, respectively. Further, in each of the sub-fields SF3-SF6 belonging to the second sub-field group SG2, the panel driving section executes the selective write addressing stage Wc and sustain stage Ic, respectively. The panel driving section executes the full erasure stage Ec only for the first sub-field SF3 in the second sub-field group SG2 prior to the selective write addressing stage Wc. Also, in each of the sub-fields SF9-SF12 belonging to the third sub-field group SG3, the panel driving section executes the selective write addressing stage Wc and sustain stage Ic, respectively. The panel driving stage executes the full erasure stage Ec only for the first sub-field SF9 in the third sub-field group SG3 prior to the selective write addressing stage Wc.

Since the operations in the full erasure stage Ec, selective write addressing stage Wc, and sustain stage Ic are the same as those described in connection with FIG. 15, description thereon is omitted.

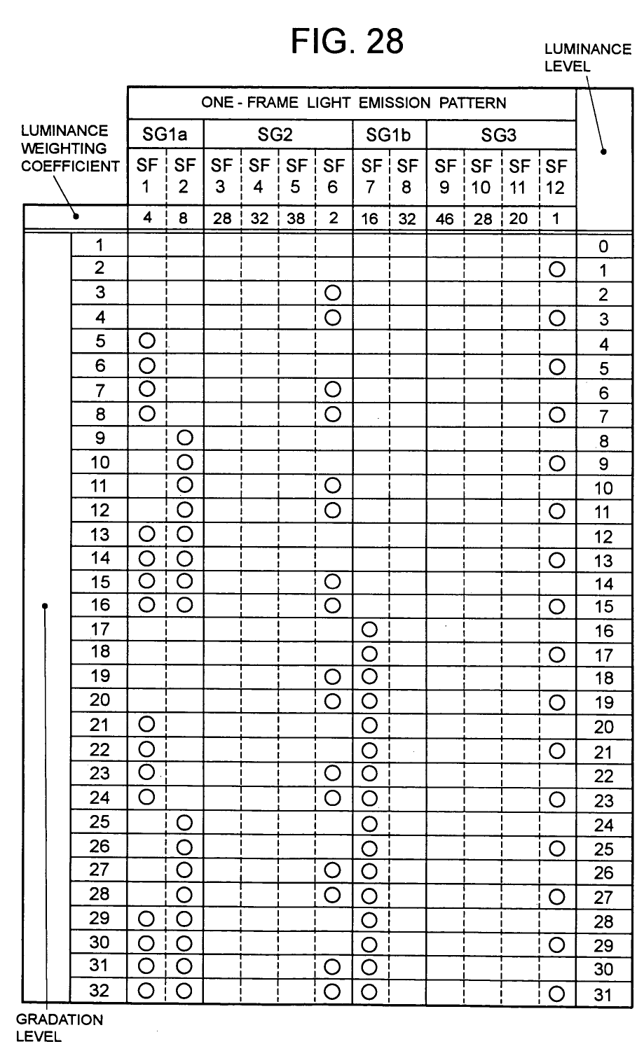

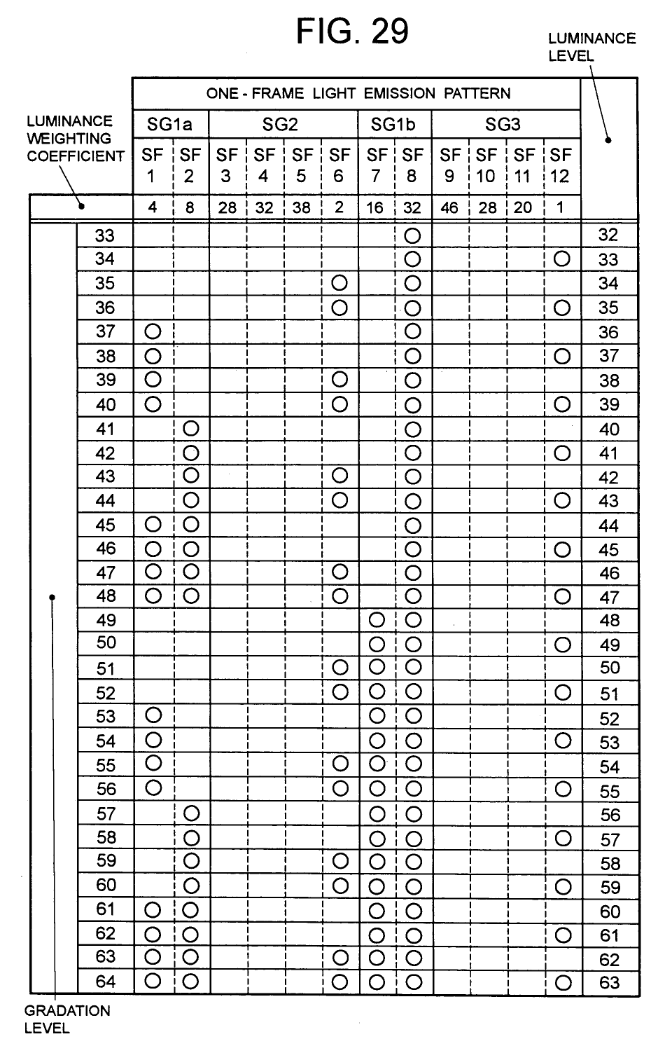

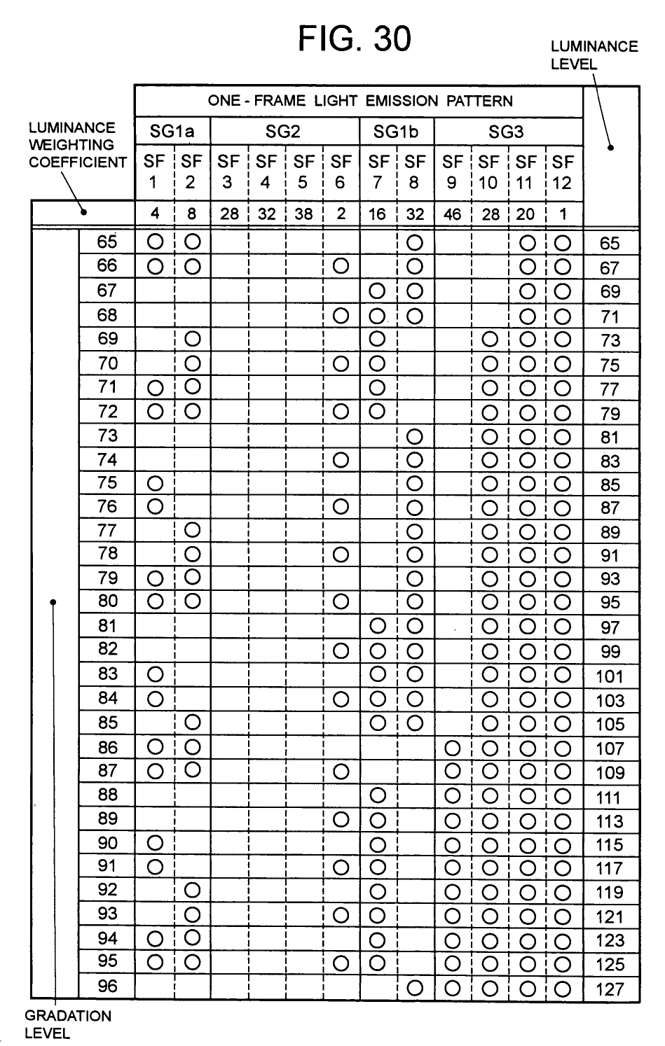

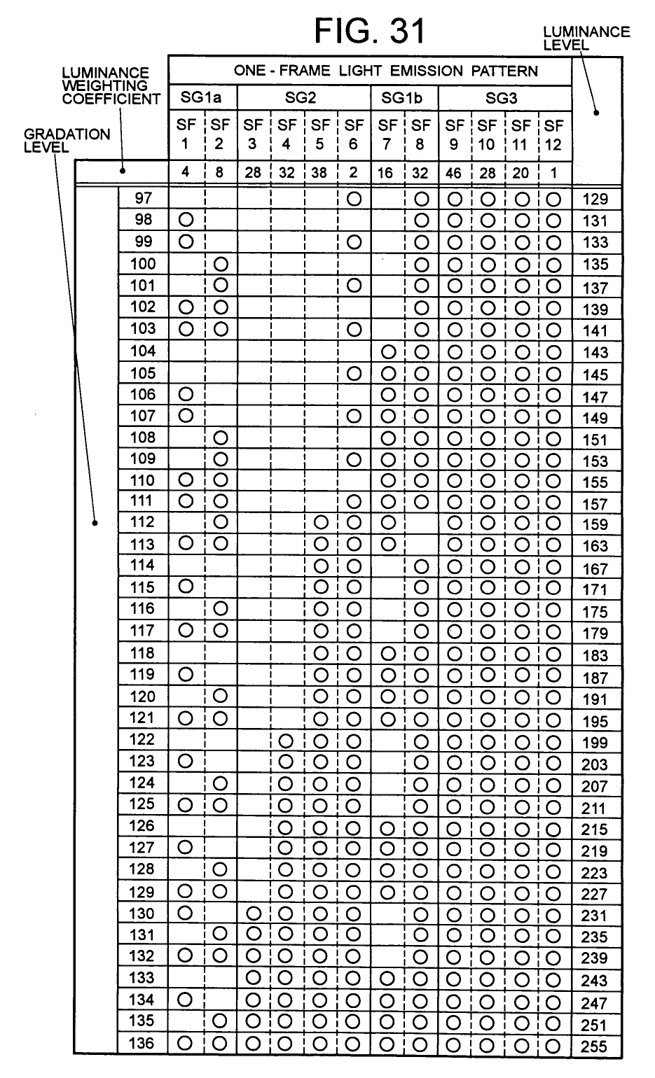

FIGS. 28 to 31 are diagrams showing light emission driving patterns in one frame display period when the panel driving section drives the PDP 10 in accordance with a luminance level indicated by an input video signal based on the light emission driving sequence shown in FIG. 27.

In FIGS. 28 to 31, in a sub-field SF marked with a white circle, discharge cells are set to the light emitting mode, so that the discharge cells emit light over a period corresponding to the luminance weighting as described above.

In the driving patterns shown in FIGS. 27 to 31, a combination of light emitting sub-fields (indicated by a circle) in one frame display period comprised of:

SF1 and SF2 belonging to First Divided Sub-field Group SG1a;

SF7 and SF8 belonging to First Divided Sub-field Group SG1b;

SF6 belonging to Second Sub-field Group SG2; and

SF12 belonging to Third Sub-field Group SG3, the luminance lower than a predetermined luminance level (65th level of gradation) is represented at 64 levels (first to 64th levels of gradation).

Here, in the light emission driving sequence shown in FIG. 27, the full erasure stage Ec is provided in each of the sub-fields of the first divided sub-field group SG1a and first divided sub-field group SG1b. However, the full erasure stage Ec is provided only for the first sub-field SF3, SF9 in the second sub-field group SG2 and third sub-field group SG3, respectively. In other words, it is only the first sub-field SF3 which gives an opportunity of switching discharge cells from the light emitting mode to the non-light emitting mode in the second sub-field group SG2, and it is only the first sub-field SF9 in the third sub-field group SG3 which gives such an opportunity. Therefore, once a discharge cell is set to the light emitting mode in any of the sub-fields SF3 to SF6, the discharge cell is subsequently maintained in the light emitting mode until the last sub-field SF6, so that the sustain discharges are produced in succession to emit light in each sub-field. Similarly, in the third sub-field group SG3, once a discharge cell is set to the light emitting mode in any of the sub-fields SF9-SF12, the discharge cell is subsequently maintained in the light emitting mode until the last sub-field SF12, so that the sustain discharges are produced in succession to emit light in each sub-field.

Therefore, in the second sub-field group SG2, four levels of luminance are represented with the values of the following luminance weighting coefficients:

“2”:light emitted only in SF6;

“40”:light emitted in each of SF5 and SF6;

“72”:light emitted in each of SF4-SF6; and

“100”:light emitted in each of SF3-SF6

by four types of light emission patterns in which the discharge cell continues the light emitting state in succession until the last sub-field SF6 once the discharge cell has been set to the light emitting state, such as:

light emitted only in SF6;

light emitted in each of SF5 and SF6;

light emitted in each of SF4-SF6;

light emitted in each of SF3-SF6.

In the third sub-field group SG3, in turn, four levels of luminance are represented with the values of the following luminance weighting coefficients:

“1”:light emitted only in SF12;

“21”:light emitted in each of SF11 and SF12;

“49”:light emitted in each of SF10-SF12; and

“95”:light emitted in each of SF9-SF12

by four types of light emission patterns in which the discharge cell continues the light emitting state in succession until the last sub-field SF6 once the discharge cell has been set to the light emitting state, such as:

light emitted only in SF12;

light emitted in each of SF11 and SF12;

light emitted in each of SF10-SF12;

light emitted in each of SF9-SF12.

Consequently, higher luminance levels above the predetermined luminance level are represented at 72 levels of gradation (65th to 136th levels of gradation) with a combination of the light emission patterns for four levels of gradation in each of the second sub-field group SG2, third sub-field group SG3, first divided sub-field group SG1a, and first divided sub-field group SG1b.

Specifically, when an input video signal can represent luminance levels “0”-“255,” low luminance components at luminance levels from “0” to “63” are represented at 64 levels (first to 64th levels of gradation) in increments of luminance level “1.” On the other hand, a high luminance range at luminance levels from “64” to “158,” higher than “63,” is represented at 47 levels of gradation (65th to 111th levels of gradation) in increments of luminance level “2.” Further, a range of luminance levels from “159” to “255” is represented at 25 levels of gradations (112th to 136 levels of gradation) in increments of luminance level “4.”

In this event, there is no combination of light emission patterns which present the inversion of a discharge cell from a light emitting period to a non-light emitting period and vice versa in the four types of light emission patterns in each of the second sub-field group SG2 and the third sub-field group SG3 in which sub-fields are arranged with large luminance weighting coefficients assigned thereto so that spurious borders are relatively prominent. Therefore, it is possible to represent 136 levels of luminance with 12 sub-fields SF1-SF12 while suppressing the spurious borders.

While FIGS. 27 to 31 show the operations when the selective write addressing method is employed to drive the PDP 10, these operations may be performed using the selective erasure addressing method.

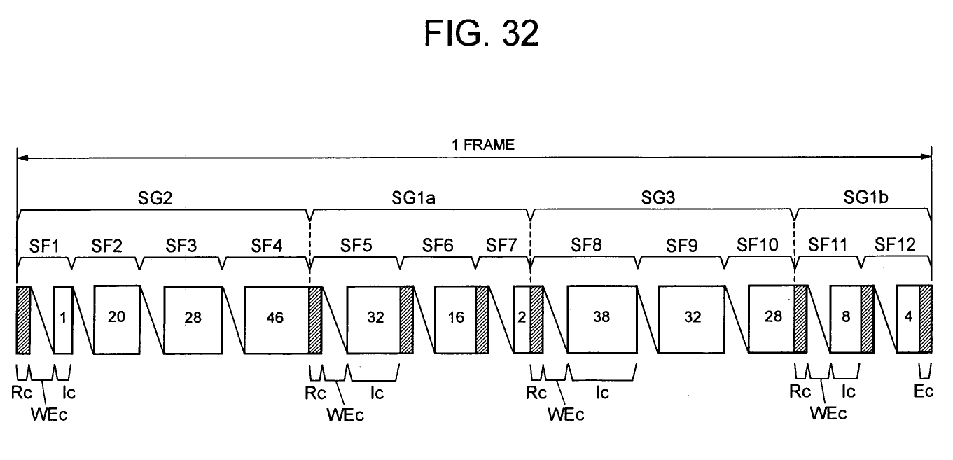

FIG. 32 is a diagram showing an example of a light emission driving sequence used when the selective erasure addressing method is employed to drive the PDP 10.

In the light emission driving sequence shown in FIG. 32, luminance weighting coefficients are applied to the sub-fields SF1-SF12, respectively, as follows:

SF1: 1

SF2: 20

SF3: 28

SF4: 46

SF5: 32

SF6: 16

SF7: 2

SF8: 38

SF9: 32

SF10: 28

SF11: 8

SF12: 4

In this event, the sub-fields SF1-SF4 belonging to the second sub-field group SG2 for emitting light of high luminance components, and the sub-fields SF5-SF7 belonging to the first divided sub-field group SG1a for emitting light of low luminance components are arranged in the former half of one frame display period, as shown in FIG. 32. On the other hand, the sub-fields SF8-SF10 belonging to the third sub-field group SG3 for emitting light of high luminance components, and the sub-fields SF11 and SF12 belonging to the first divided sub-field group pSG1b for emitting light of low luminance components are arranged in the latter half of one frame display period.

Specifically, in the first divided sub-field group SG1a, the SF5 and SF6 are arranged such that the values of the luminance weighting coefficients assigned thereto decrease from the head to the tail in a form of geometric series with a common ratio set to 1/2, with the sub-field SF7 having the second smallest luminance weighting coefficient placed at the tail of the sequence. In the first divided sub-field group SG1b, the SF11 and SF12 are arranged such that the values of the luminance weighting coefficients assigned thereto decrease from the head to the tail in a form of geometric series with a common ratio set to 1/2. In the second sub-field group GS2, the first sub-field SF1 having the smallest luminance weighting coefficient is placed at the head, and subsequently, SF2, SF3, SF4 are arranged such that the values of their luminance weighting coefficients increase in order. In the third sub-field group SG3, in turn, SF8, SF9, SF10 are arranged such that the values of their luminance weighting coefficients decrease from the head to the tail.

In the foregoing arrangement, the sub-field SF4 having the largest luminance weighting coefficient and SF8 having the next largest luminance weighting coefficient are distributively placed in the former half and latter half of one frame display period, respectively. Also, the sub-field SF7 having the second smallest luminance weighting coefficient is placed immediately before the third sub-field group SG4. In other words, this SF7 is placed at the center of one frame display period. Further, the sub-field SF1 having the smallest luminance weighting coefficient, and SF12 having the third smallest luminance weighting coefficient are distributively placed at the head and at the tail of one frame display period, respectively.

Here, in each of sub-fields SF1-SF4 belonging to the second sub-field group SG2, the panel driving section executes the selective erasure addressing stage WEc and sustain stage Ic, respectively. The panel driving section executes a reset stage Rc only for the first sub-field SF1 in the second sub-field group SG2 prior to the selective erasure addressing stage WEc. Also, in each of the sub-fields SF5-SF7 belonging to the first divided sub-field group SG1a, the panel driving section executes the reset stage Rc, selective erasure addressing stage WEc, and sustain stage Ic, respectively. Further, in each of the sub-fields SF8-SF10 belonging to the third sub-field group SG3, the panel driving section executes the selective erasure addressing stage WEc and sustain stage Ic, respectively. The panel driving section executes the reset stage Rc only for the first sub-field SF8 in the third sub-field group SG3 prior to the selective erasure addressing stage WEc. Also, in each of the sub-fields SF11 and SF12 belonging to the first divided sub-field group SG1b, the panel driving section executes the reset stage Rc, selective erasure addressing stage WEc, and sustain stage Ic, respectively.

Since the operations in the reset stage Rc, selective erasure addressing stage Wc, and sustain stage Ic are the same as those described in connection with FIG. 15, description thereon is omitted.

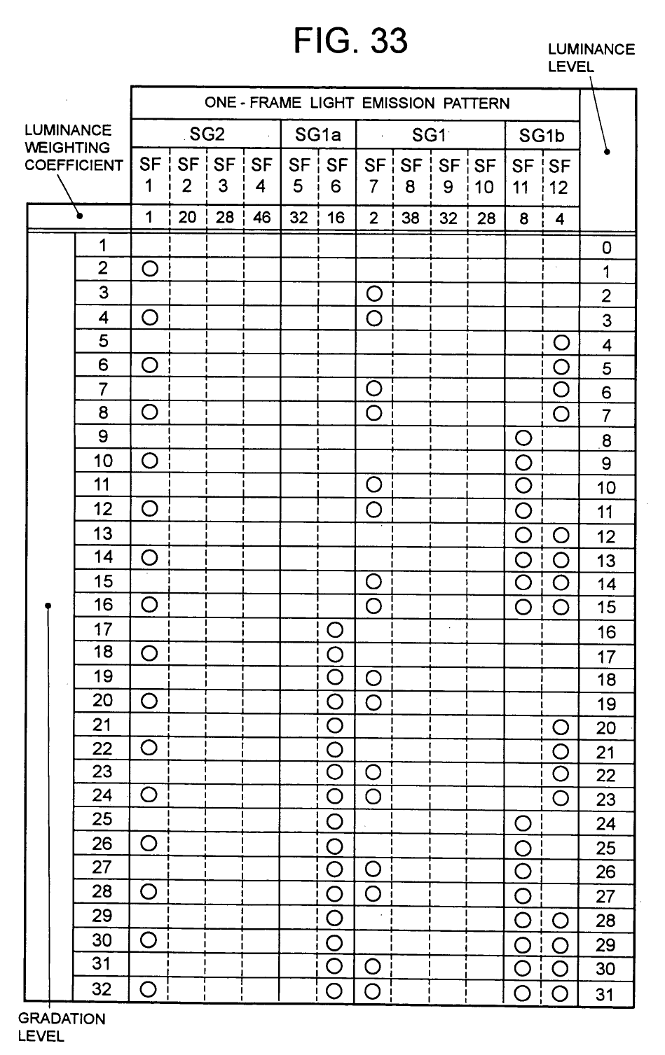

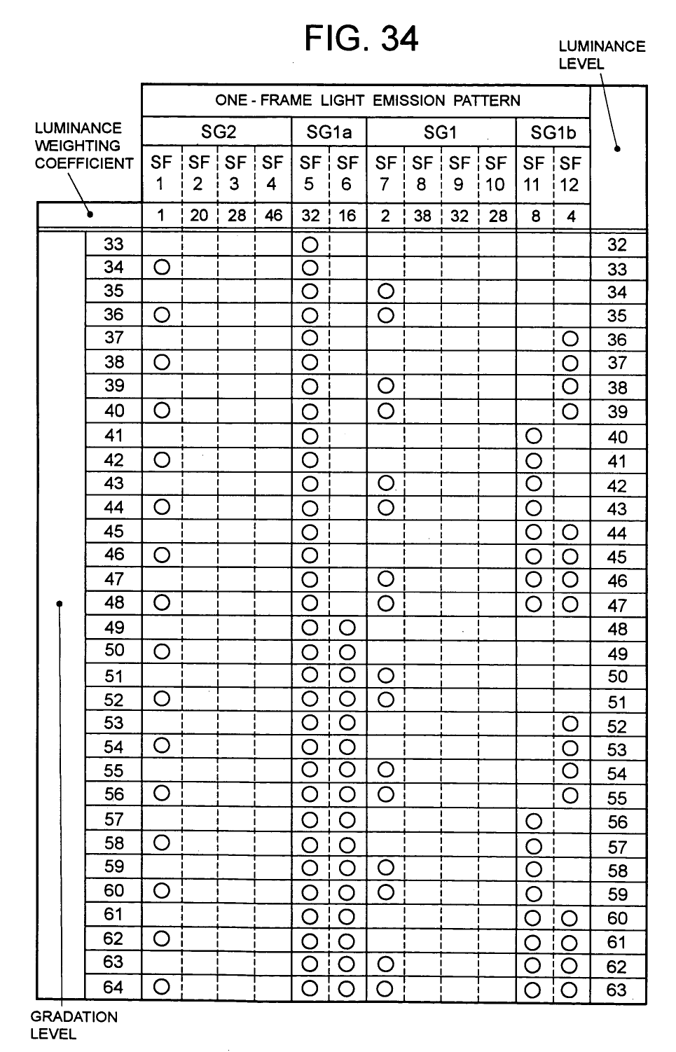

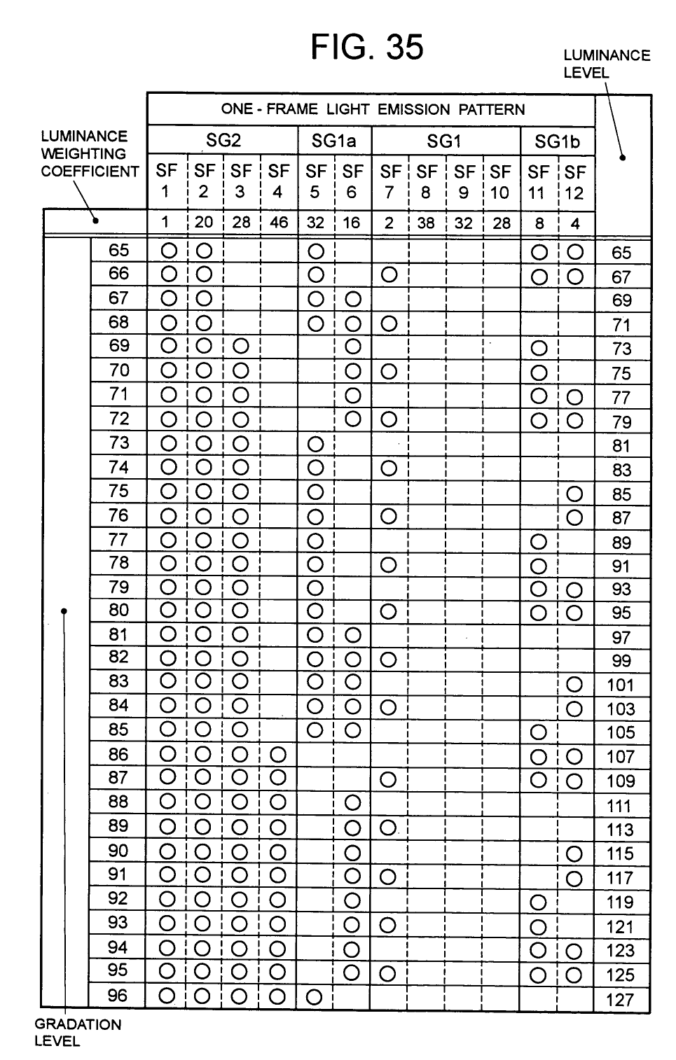

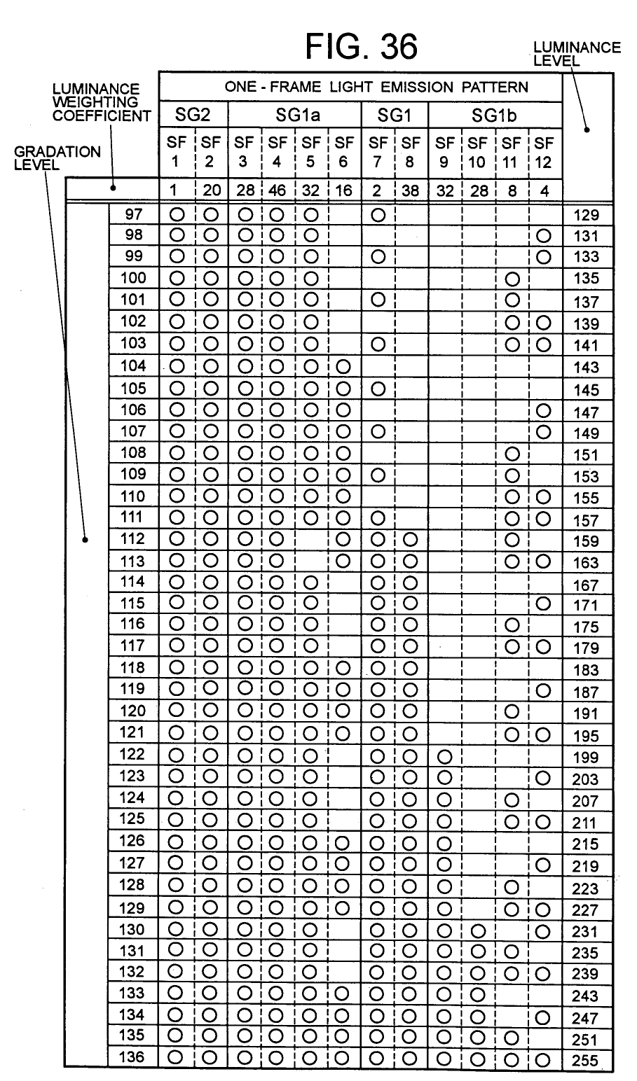

FIGS. 33 to 36 are diagrams showing light emission driving patterns in one frame display period when the panel driving section drives the PDP 10 in accordance with a luminance level indicated by an input video signal based on the light emission driving sequence shown in FIG. 32.

In FIGS. 33 to 36, in a sub-field SF marked with a white circle, discharge cells are set to the light emitting mode, so that the discharge cells emit light over a period corresponding to the luminance weighting coefficient as described above.

Specifically, the driving patterns shown in FIGS. 32 to 36 are similar to the driving technique shown in FIGS. 32 to 36 in that an input video signal representing low luminance levels in a range of “0” to “63” is represented at 64 levels (first to 64th levels of gradation) in increments of luminance level “1.” On the other hand, a high luminance range at luminance levels from “64” to “158,” higher than “63,” is represented at 47 levels of gradation (65th to 111th levels of gradation) in increments of luminance level “2.” Further, a range of luminance levels from “159” to “255” is represented at 25 levels of gradations (112th to 136 levels of gradation) in increments of luminance level “4.”

In this event, there is no combination of light emission patterns which present the inversion of a discharge cell from a light emitting period to a non-light emitting period and vice versa in the four types of light emission patterns in each of the second sub-field group SG2 and the third sub-field group SG3 in which sub-fields are arranged with large luminance weighting coefficients assigned thereto so that spurious borders are relatively prominent. Therefore, it is possible to represent 136 levels of luminance with 12 sub-fields SF1-SF12 while suppressing the spurious borders, in a manner similar to the driving technique shown in FIGS. 27 to 31.

This application is based on Japanese Patent Application No. 2004-191115 which is hereby incorporated by reference.

1. A method of driving a plasma display panel having a plurality of discharge cells corresponding to pixels every N sub-fields (N is an integer equal to or larger than two) defining each frame display period, wherein:
each of said sub-fields comprises an addressing step for setting each of the discharge cells to one of a light emitting mode or a non-light emitting mode in accordance with pixel data corresponding to an input video signal, and a sustaining step for forcing only the discharge cells set in the light emitting mode to repeatedly produce sustain discharges a number of times corresponding to a luminance weighting coefficient assigned to each of the sub-fields to sustain a light emitting state,
each frame display period includes a first sub-field group which has a plurality of the sub-fields arranged in succession such that the values of the luminance weighting coefficients assigned to the respective sub-fields advance in a form expressed by:
G(n)=2⁽ⁿ⁻¹⁾
where G represents Value of Luminance Weighting Coefficient, and
n represents Position of Sub-field in Group, and
a second sub-field group including a sub-field having the largest luminance weighting coefficient of the N sub-fields and having a plurality of sub-fields arranged in succession such that the values of the luminance weighting coefficients assigned to the respective sub-fields advance in a form expressed by:
G(n)=a+(n-1)·d
where G represents Value of Luminance Weighting Coefficient,
n represents Position of Sub-field in Group,
a represents Initial Value of Luminance Weighting Coefficient, and
d represents Predetermined Value, and
the sub-field having the largest luminance weighting coefficient is placed at a position other than the head and the tail of the frame display period.

2. A method of driving a plasma display panel according to claim 1, wherein:
said addressing step includes selectively forcing the discharge cells to produce a write address discharge therein in accordance with the pixel data to switch the discharge cells in the non-light emitting mode to the light emitting mode;
said first sub-field group has a plurality of the sub-fields arranged in succession such that the values of the luminance weighting coefficients assigned to the respective sub-fields increase from the head to the tail; and
said second sub-field group has a plurality of the sub-fields arranged in succession such that the values of the luminance weighting coefficients assigned to the respective sub-fields decrease from the head to the tail.

3. A method of driving a plasma display panel according to claim 2, wherein said discharge cells are set to the light emitting mode in each of a number of sub-fields corresponding to a luminance level indicated by the input video signal, said sub-fields being arrange in succession in an order in which said sub-fields are assigned smaller luminance weighting coefficients.

4. A method of driving a plasma display panel according to claim 2, wherein in each of the N sub-fields, a sub-field having the largest luminance weighting coefficient is placed at the tail of said second sub-field group.

5. A method of driving a plasma display panel according to claim 2, wherein said first sub-field group is place in the former half of one frame display period, and said second sub-field group is placed in the latter half of one frame display period.

6. A method of driving a plasma display panel according to claim 1, wherein:
said addressing step includes forcing the discharge cells to produce an erasure address discharge therein in accordance with the pixel data to switch the discharge cells in the light emitting mode to the non-light emitting mode;
said first sub-field group has a plurality of the sub-fields arranged in succession such that the values of the luminance weighting coefficients assigned to the respective sub-fields increase from the head to the tail; and
said second sub-field group has a plurality of the sub-fields arranged in succession such that the values of the luminance weighting coefficients assigned to the respective sub-fields increase from the head to the tail.

7. A method of driving a plasma display panel according to claim 6, wherein said discharge cells are set to the light emitting mode in each of a number of sub-fields corresponding to a luminance level indicated by the input video signal, said sub-fields being arranged in succession in an order in which said sub-fields are assigned smaller luminance weighting coefficients in the second sub-field group.

8. A method of driving a plasma display panel according to claim 2, wherein the sub-field assigned the smallest luminance weighting coefficient in each of the N sub-fields is placed at the head of the second sub-field group.

9. A method of driving a plasma display panel according to claim 6, wherein said second sub-field group is placed in the former half of one frame display period, and said first sub-field group is placed in the latter half of one frame display period.

10. A method of driving a plasma display panel having a plurality of discharge cells corresponding to pixels every N sub-fields (N is an integer equal to or larger than two) defining each frame display period, wherein:
each of said sub-fields comprises an addressing step for setting each of the discharge cells to one of a light emitting mode or a non-light emitting mode in accordance with pixel data corresponding to an input video signal, and a sustaining step for forcing only the discharge cells set in the light emitting mode to repeatedly produce sustain discharges a number of times corresponding to a luminance weighting coefficient assigned to each of the sub-fields to sustain a light emitting state,
each frame display period includes a first sub-field group having a plurality of the sub-fields arranged in succession such that the values of the luminance weighting coefficients assigned to the respective sub-fields advance in a form of geometric series with a common ratio being set to two, a second sub-field group including a plurality of the sub-field group arranged such that the values of the luminance weighting coefficients increase from the head to the tail, and a third sub-field group having a plurality of the sub-fields arranged such that the values of the luminance weighting coefficients decrease from the head to the tail, and
a sub-field assigned the largest luminance weighting coefficient in the N sub-fields is placed at a position other than the head and the tail of the frame display period.

11. A method of driving a plasma display panel according to claim 10, wherein said discharge cells are set to the light emitting mode in each of a number of the sub-fields corresponding to a luminance level indicated by the input video signal, said sub-fields being arranged in succession in an order in which said sub-fields are assigned smaller luminance weighting coefficients in the second or third sub-field group.

12. A method of driving a plasma display panel according to claim 10, wherein:
said addressing step includes selectively forcing the discharge cells to produce a write address discharge therein in accordance with the pixel data to switch the discharge cells in the non-light emitting mode to the light emitting mode; and
a sub-field assigned the second smallest luminance weighting coefficient in the N sub-fields is placed at the tail of the second sub-field group.

13. A method of driving a plasma display panel according to claim 10, wherein:
said addressing step includes selectively forcing the discharge cells to produce an erasure address discharge therein in accordance with the pixel data to switch the discharge cells in the light emitting mode to the non-light emitting mode; and
a sub-field assigned the second smallest luminance weighting coefficient in the N sub-fields is placed immediately before the third sub-field group.
